(19) United States
(12) Patent Application Publication
(10) Pub. No.: US 2026/0278615 A1
(43) Pub. Date: Sep. 17, 2026

(54) SYSTEM AND METHOD FOR SCREENING USER INPUTS UTILIZING A HYBRID SEARCH MODEL

(71) Applicant: PAYPAL, INC., San Jose, CA (US)

(72) Inventors: Sanjay Thimmarayappa, San Jose, CA (US); Gagandeep Singh, San Jose, CA (US); Akshay Josyula Manglik, San Jose, CA (US)

(21) Appl. No.: 19/078,737

(22) Filed: Mar. 13, 2025

(51) Int. Cl. G06Q 20/42; G06N 20/00; G06Q 30/018

(52) U.S. Cl. CPC G06Q 20/42; G06N 20/00; G06Q 30/018

(57) ABSTRACT

System and method for screening entities based on user inputs can include receiving a user request for generating a search sequence associated with an electronic transaction, obtaining a first dataset associated with the electronic transaction based on parameters of the user request, obtaining a second dataset for matching with the first dataset based on the parameters, providing an output dataset including match scores based on determining a similarity between the first and second datasets using a search model, and performing one or more pre-defined actions in response to a match score exceeding a certain threshold indicative of a positive match between the first and second datasets. The one or more inputs can define the parameters for the search sequence. The search model can include a first model and a second model, the second model refining the first model results based on a semantic context.

### FIELD

The present disclosure relates to the field of data analytics. More particularly, to hybrid sanctions screening of user queries.

### BACKGROUND

Sanctions screening is generally implemented in a computing environment or computing system of an entity to ensure compliance with regulations. Sanctions screening typically includes the identification and prevention of electronic transactions associated with certain individuals or entities that are included in a sanctions list from being performed. The sanctions list can be, for example, a government or international sanctions list. The individuals or entities included in these lists can be associated with performing illegal activities in the one or more relevant jurisdictions associated with the sanctions list. The individuals or entities can be associated with, for example, money laundering, drug-trafficking, terrorism, or other types of illegal activities in the one or more jurisdictions. Accordingly, an entity can screen the electronic transactions being performed in the computing environment or computing system of the entity to prevent facilitating transactions with sanctioned individuals or other entities.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a block diagram of an example system for screening user inputs to identify a match to a list of data entries and performing responsive actions, according to some embodiments.

FIG. 2 is a flow diagram of an example method for screening the user inputs, according to some embodiments.

FIG. 3 is a block diagram of an example system for screening the user inputs, according to some embodiments.

FIG. 4 is a flow diagram of an example system performing a search query, according to some embodiments.

FIG. 5 is a block diagram of an example system for screening the user inputs, according to some embodiments.

FIG. 6 is a flow diagram of an example method for screening the user inputs, according to some embodiments.

FIG. 7 is a block diagram of an example system for screening the user inputs, according to some embodiments.

FIG. 8 is a flow diagram of an example method for screening the user inputs, according to some embodiments.

FIG. 9 is a block diagram of an example system for screening the user inputs, according to some embodiments.

FIG. 10 is a flow diagram of an example method for screening the user inputs, according to some embodiments.

FIG. 11 is a block diagram of an example system for screening the user inputs, according to some embodiments.

FIG. 12 is a flow diagram of an example method for screening the user inputs, according to some embodiments.

FIG. 13 is a block diagram of an example system for screening the user inputs, according to some embodiments.

FIG. 14 is a block diagram of an example computing system, according to some embodiments.

### DETAILED DESCRIPTION

An entity that implements a computing system or computing environment that can be utilized by users to perform electronic transactions with other users can perform sanctions screening of the users associated with the electronic transactions to ensure compliance with regulations and to prevent inadvertently facilitating electronic transactions by sanctioned individuals or entities. The sanctions screening typically includes identifying if the individuals or entities associated with a particular electronic transaction is included in a sanctions list. The sanctions list can be, for example, a government or international sanctions list of individuals or entities associated with illegal activities including, but not limited to, money laundering, drug-trafficking, terrorism, or other types of illegal activities, within the one or more jurisdictions.

Various embodiments of the present disclosure relate to systems and methods for performing screenings in a computing system or computing environment of an entity. The computing system of the entity can include, but is not limited to, an electronic transaction processing system, a screening system, and a database storing one or more lists associated with the screening. The screening system can be utilized in conjunction with the data transaction processing system to screen the electronic transactions at a certain interval to ensure regulatory compliance and to prevent inadvertently facilitating illegal electronic transactions.

The electronic transaction processing system can be utilized by users to perform electronic transactions in the computing system of the entity. For example, a user can perform electronic transactions for purchasing goods or services from merchants using the electronic transaction processing system. For example, a user can transfer electronic funds between the user and another user using the electronic transaction processing system of the entity. The screening system can screen the electronic transactions performed utilizing the electronic transaction processing system or another system (e.g., embedded service) associated with the computing system of the entity.

The screenings can include, for example and without limitation, receiving a user generated query defining parameters of a screening workflow to be performed by the screening system, performing a search to identify a match between data obtained from the user query and data from the database using one or more search models, and, initiating, in response to a positive match result, an action according to one or more rules. The user query can be generated by, for example, a sanctions screening individual of the entity to ensure that the entity does not inadvertently facilitate electronic transactions by individuals or entities included in a sanctions list. The screening system can be provided, for example, as an embedded service to users performing electronic transactions using the electronic transaction processing system of the entity to ensure that the user (e.g., merchant) does not inadvertently perform electronic transactions with other individuals or entities included in a sanctions list of a certain jurisdiction or jurisdictions where the user has business operations offering their goods or services. Performing the search includes utilizing a hybrid search model to determine if the data obtained from the user query matches the data from the database. The hybrid search model can employ at least one of a first search model or a second search model to determine if the data obtained from the user query matches the data from the database. In some embodiments, the screening system can generate a first set of results by applying the data from the user query to the first search model, the screening system can generate a second set of results by applying the data from the user query to the second search model, and the screening system can consolidate the first set of results and the second set of results to provide at least one result that corresponds to a positive match between the data from the user query and the data from the database in response to the user query. In some embodiments, the screening system can include a screening engine configure one or more use cases

In some embodiments, for example, the screening system can be configured to perform the screenings in a live computing environment in real time (RT) or near real time (NRT) as the transactions are initiated in the electronic transaction processing system so as to reduce a latency of the screening function. In some embodiments, the screening system can be configured to perform the screenings on batches of electronic transaction data at periodic intervals to reduce a demand (e.g., processing requirements) on the screening system or the computing system of the entity. For example, the screening system can be utilized multiple times a day, once a day, or less frequently, to screen a batch dataset of electronic transactions.

The database can include, for example, one or more sanctions lists including data of individuals or entities that are restricted from performing electronic transactions in a certain jurisdiction or jurisdictions. The one or more sanctions list can include, for example, a name of each individual or entity. The database can further include, for example, aliases of the individuals or entities included in the one or more sanctions lists. The database can include any of a plurality of information including, but not limited to, user account data, user personal data, user behavior data, historical data, device data, location data, known aliases, positive match results or negative match results determined by the screening system, other types of data associated with the electronic transactions and/or the users associated with the electronic transactions, or any combination thereof.

The embodiments of the present disclosure provide a screening system that yields improved positive match determination for input data that may not be an exact match to the data from the dataset. The screening system thereby reduces, for example, a frequency of missing matches between users performing electronic transactions in the computing system of the entity that are included in the sanctions list of individuals or entities stored in the database. Accordingly, the embodiments of the present disclosure can limit and/or reduce the frequency of the entity incurring potential fines for such transactions, reduce potential harm to the entity's brand and reputation through association with bad actors, reduce the risk of compromising consumer, shareholder, and government trust in the entity as a responsible actor, and provides a system capable of flexibly matching content, which can save from having to generate new lists and algorithms to address, for example, synonyms and abbreviations of names of individuals or entities included in the sanctions list in a piecemeal fashion.

The embodiments of the present disclosure improve upon other known approaches that utilize keyword-based search methodologies by providing a screening system that provides a screening engine that leverages hybrid search model to screen data associated with electronic transactions and identify a potential match with data from a database. Although the searching techniques utilized by other known approaches can tolerate relatively slight distinctions while still being capable of identifying a match between strings of text, the search techniques utilized by these other screening systems are dependent on the letters and words themselves to identify the full or partial matches between strings of text. The embodiments of the present disclosure improve upon the other screening systems by implementing a hybrid search approach that utilizes at least one of a first model and a second model. The screening engine implements at least one of the first model or the second model to determine a match between data associated with an electronic transaction and data from a database. The screening engine can dynamically implement at least one of the first model or second model in either synchronous or asynchronous mode to determine the match(es). The screening system can thereby leverage the first model to identify matches based on keyword-based lexical content, and the screening system can leverage the second model to identify matches based on semantic content. The screening system can also consolidate the results output by the first model and the second model to refine the results, the matching result being identified from the consolidated results that has a highest positive match score.

The first model can be a keyword search model configured to determine if the data associated with the electronic transaction (e.g., individual name or entity name) matches a full or partial string from the data from the database. For example, the first model may match queries of “Eagle” or “Eagle Pharma” to “Eagle Pharmaceuticals,” because the query string matches a full or partial string of the data from the database. Accordingly, the first model utilizes techniques that depend on the letters and words rather than on the underlying meaning of the words. The first model can generate a match score representative of the data associated with the electronic transaction matching the data from the database. In response to a match score exceeding a certain threshold, the screening system can, for example, flag the account for further investigation by a sanctions screening agent associated with the entity.

The second model can be a similarity search model configured to utilize natural language processing (NLP) to determine if a first string representative of at least a portion of the data associated with the electronic transaction matches the data from the database based on a context of the data, even if the words themselves are not an exact match. The second model can match synonyms in the data associated with the electronic transaction and the data from the database. For example, the second model can match user queries of “Eagle Drugs” with “Eagle Pharmaceuticals” from the database based on the context of the term “Drugs” and its interchangeable use with the “Pharmaceuticals” in certain instances. The second model can also match abbreviations in the data associated with the electronic transaction and the data from the database based on the context without relying on manually created lists of abbreviations mapped to similar words. For example, the second model can match the user query of “Eagle Limited” with “Eagle Ltd.,” based on the semantic content. The second model thereby identifies matches based on semantic content, rather than keyword-based lexical content as with the first model.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

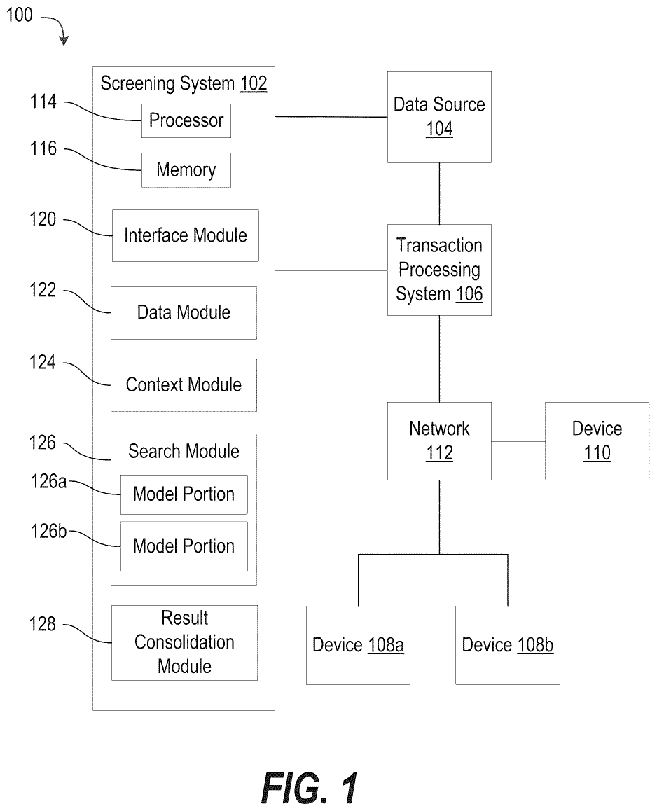

FIG. 1 is a block diagram of an example system 100 for screening user inputs associated with electronic transactions to identify a match to a list of data entries and performing responsive actions, according to some embodiments.

The system 100 can include a screening system 102, a data source 104, a transaction processing system 106, a plurality of computing devices 108 (two such computing devices 108a, 108b are shown), and one or more other computing devices 110. The system 100 can be, for example, a computing system or a networked computing environment associated with an entity or a service provider for providing one or more services associated with the entity to user computing devices in electronic communication with the system 100.

The plurality of computing devices 108 can be associated with a user in electronic communication with the transaction processing system 106. In some embodiments, the plurality of computing devices 108 can be in electronic communication with each other over a network 112.

The one or more other computing devices 110 can be associated with a merchant in electronic communication with the transaction processing system 106. In some embodiments, the plurality of computing devices 108 can be in electronic communication with the one or more other computing devices 110 using the network 112 or some other network. For example, the user of computing device 108 can purchase goods or services of the merchant using transaction processing system 106 via network 112.

According to some embodiments, the one or more other computing devices 110 can instead be a user associated the entity of system 100. For example, the user of the computing device 110 can instead be a sanctions screening agent of the entity that utilizes a screening engine of screening system 102 and inputs parameters for the screening system 102 to perform the sanctions screening. The plurality of computing devices 108 and/or the one or more other computing devices 110 can be in communication with the transaction processing system 106 or each other via the network 112 and/or another network.

Users may initiate transaction, review transactions, complete transactions, etc. on user computing devices 108 through the transaction processing system 106. Accordingly, the transaction processing system 106 can receive, from user computing device 108, instructions to initiate a transaction, an instruction to accept or complete a transaction, an instruction to review one or more transactions, an instruction to retract a transaction, etc., and may respond by performing or facilitating the requested user action and storing the data generated from the transaction in a data store such as, for example, in data source 104. Accordingly, user activity as discussed herein may include transactions instructed through the transaction processing system 106, in some embodiments, and/or user activity on one or more platforms, networks, embedded services, etc. Such transactions may include, for example, a computing transaction such as a file creation, a revision to a file, an electronic communication, a financial transaction (or component thereof), a real-estate transaction (or component thereof), a service request, or any other electronic transaction. Additionally, or alternatively, user activity according to the present disclosure may be or may include an event associated with a user, such as a user navigation to a webpage, a user search request, a user associating an external account in an external computing system associated with an external entity with the user account, a user sending electronic funds to another user's account or to an external account, etc.

The transaction processing system 106 may be associated with a particular electronic user interface and/or platform through which a user performs electronic transactions. The electronic user interface may be embodied in a website, mobile application, etc. Accordingly, the transaction processing system 106 may be associated with or wholly or partially embodied in one or more servers, which server(s) may host the interface, and through which the user computing devices 108 may access the user interface.

The user computing devices 108 may be respectively associated with different user accounts. That is, user computing device 108a may be associated with a first user account, and user computing device 108b may be associated with a second user account. Where user computing devices are discussed herein, it may be assumed that different devices are associated with different user accounts for convenience of description, though of course a single user account may be accessed from multiple devices in practical use.

According to some embodiments, the screening system 102, data source 104, and transaction processing system 106 may also be in electronic communication with each other via the network 112 and/or another network.

The screening system 102 can include a processor 114, a non-transitory, computer-readable memory 116 having stored thereon instructions that, when executed by the processor 114, cause the screening system 102 to perform one or more steps, processes, operations, methods, etc., described herein with respect to the screening system 102. The screening system 102 can include one or more functional modules embodied in the memory 116. The one or more functional modules can include an interface module 120, a data module 122, a context module 124, a search module 126, and a result consolidation module 128.

The screening system 102 can include an interface module 120. The interface module 120 can be utilized by one or more of the functional modules of screening system 102 such as, for example, the search module 126 to enable the screening system 102 to perform its steps, operations, methods, processes, etc. The interface module 120 can be utilized to send and receive data between the screening system 102 and the user computing devices such as, for example, user computing devices 110. The interface module 120 can provide an electronic user interface to a user of the user computing device. The interface module 120 can provide the prompts to the user computing device through the user interface and the interface module 120 can receive the inputs from the user computing device based on inputs at the user interface by the user. For example, the inputs can define one or more data fields (i.e., name data) to be retrieved from a user account associated with an electronic transaction to enable the screening system 102 to perform a screening search to identify a match with names for individuals and entities included in a sanctions list. In some embodiments, the transaction processing system 106 or some other system of system 100 can provide a user interface to the user computing device.

The screening system 102 can include a data module 122. The data module 122 can obtain data from one or more data sources according to the data obtained by interface module 120, the data utilized by the other functional modules of screening system 102 to perform their respective operations such as, for example, to fulfill the search use cases. The data sources can include, for example, and without limitation, user data, merchant data, sanctions watchlist data, sanctions adjudication data, other data sources, or any combination thereof.

The user data and the merchant data can include account data including, for example and without limitation, name data, personal data, language data, location data, device data, alias data, financial account data, user behavior data, external data, historical data other data associated with a user, or any combination thereof. The merchant data can include other types of data such as, for example, location data for each brick-and-mortar location, device data for any computing devices from each of the locations performing transactions using transaction processing system 106, user accounts that are authorized to perform transactions for the merchant account, other data associated with the merchant, or any combination thereof.

The sanctions watchlist data can include a list of sanctioned individuals and entities. The sanctions watchlist data can group the sanctioned individuals and entities into one or more lists. For example, the sanctioned individuals and entities in the sanctions watchlist data can be grouped by respective jurisdictions. For example, a user may be included in a sanctions list of one jurisdiction, and thereby cannot perform electronic transactions in the one jurisdiction but may be able to perform electronic transactions in one or more other jurisdictions.

In the event a match score generated for an input from the one or more search use cases exceeds a certain threshold limit, the screening system 102 may perform one or more additional actions in response to the event. The additional actions can include, in some embodiments, triggering a flag of the event for further adjudication by a user of the entity of system 100 (e.g., sanctions screening agent). The user of the entity can then make a final determination of whether the flagged input is a match with a name of an individual or entity included in the sanctioned watchlist data. For example, the sanctions screening agent can indicate whether the flag is a true/false positive. Based on the final determination, the data from the indication along with other corresponding metadata can be stored as sanctions adjudication data by the data module 122. In some embodiments, the other corresponding metadata can include, for example and without limitation, electronic transaction data, name or alias data from the user input, user behavior data, device data, location data, other data, or any combination thereof.

The data module 122 can also store data generated based on the operations of the other functional modules of screening system 102. When a user requests to initiate a transaction using transaction processing system 106, for example, the user can provide input data including, but not limited to, a user name or alias corresponding to an individual or entity associated with the transaction request, a name or alias of a source user corresponding to an individual or entity associated with the transaction if different from the user that initiated the request, a name or alias of a target user corresponding to an individual or entity associated with the transaction if different from the user that initiates the request and different from the source user. For example, the data module 122 can associate an alias obtained from the user inputs that results in a match score that exceeds a certain threshold level indicative of a positive or negative match result with the user account. For example, the data module 122 can update a sanctions list or some other list and associate an alias obtained from the user inputs from a transaction that results in a match score that exceeds a certain threshold level indicative of a positive or negative match result with the name of the individual or entity included in the sanctions list for faster identification of matches in future search use cases.

The instant disclosure refers to users, individuals, entities, accounts, electronic transactions, and other electronic activity. Such accounts may be accounts common to a particular service provider, a particular network, a particular electronic activity processor, etc. For example, the accounts may be accounts with the transaction processing system 106, and the users may be users associated with those accounts. The electronic transactions and other activity may be transactions processed by, or other activity in or through, the transaction processing system 106, and/or transactions and activity outside of the transaction processing system 106. For example, the screening system 102 of system 100 can be utilized to screen for sanctioned users from electronic activity data from embedded services external to transaction processing system 106. Although this disclosure refers to electronic transactions as context for the novel methods and systems, it should be understood that such methods and systems can be applied to or in the context of a wide variety of computing actions, some of which may not be considered transactions. For example, where past transactions are considered herein, past computing actions may more broadly be considered. Similarly, where present transactions are responded to herein, present computing actions may more broadly be responded to. For example, the electronic activity can be a new account being created in the transaction processing system 106 and the screening system 102 can perform the screening steps of the present disclosure to identify a potential match from the sanctions list based on the data input by the user creating the new account.

The screening system 102 can include a context module 124. In some embodiments, the context module 124 can enable a user (e.g., data scientist or sanctions screening agent) of an entity of system 100 to configure a search workflow to perform one or more search use cases by the one or more functional modules of the screening system 102. The workflow can be configured based on inputs from the user at a user interface obtained by a user computing device such as, for example, user computing device 110 from the interface module 120 of screening system 102. In other embodiments, the context module 124 can configure a search workflow based on receiving inputs from other modules and/or based on analysis of certain data.

Each search use case can be performed according to a specific context, which can be configured by the user (e.g., by configuring how they want to categorize each of the use cases based on their inputs). The specific context can determine, for example and without limitation, what types of searches to perform, indexes and/or vector datasets to retrieve, models that are to be applied to the data, etc. In other embodiments, the specific context can be determined based on a configuration schema, which can be utilized to validate the user's search query. In some embodiments, the configuration schema can provide a series of prompts to the user to enable the user to provide the configuration for each search use case. In other embodiments, the configuration schema can include a default configuration that can be automatically performed on data. For example, the default configuration can be performed using data having a known set of fields. In some embodiments, the default configuration can be updated to expand the system's capabilities such as, for example, to provide the service to other applications, to utilize the search use cases for identifying similarities on other types of data beyond entity names, etc. Search use cases can include, for example and without limitation, a search for matches with an official sanctions list from a governmental or international entity or organization, a search for matches with an exemptions list, a search for matches with a list of suspected bad actors, a search for matches with data from electronic documents associated with negative news from one or more electronic sources (e.g., webpages, social media, emails, etc.).

In some embodiments, the context module 124 can provide prompts to a user to configure each search use case to be performed by the screening system 102. The prompts provided to the user computing device at the user interface by the context module 124 can be configured such that user, in response to the prompts, provides inputs at the user computing device including, for example and without limitation, defining each use case category, defining one or more input fields to be obtained to perform the use case, defining pre search conditions, defining search conditions, establishing result consolidation conditions, or any combination thereof. In some embodiments, the search workflow can be configured such that one or more results from a search use case can be provided as inputs to a subsequent search use case according to their respective contexts.

In some embodiments, a search workflow can be configured to identify matches with an exemptions list of entities by obtaining outputs from a previous search use case and identify potential matches between the results from the first use case and the entries in the exemptions list using the hybrid search model. In some embodiments, for example, the search workflow can define a first use case that obtains “x,” “y,” and “z” input fields from a transaction and identifies a match between one or more of the obtained input fields and a first index corresponding to a sanctions list using a hybrid search model, and the search workflow can define a second use case that obtains “a” and “b” input fields from the transaction, obtains results from matches for the “x” and “y” fields from the first use case, and identifies a match between the obtained results from matches for the “x” and “y” fields and a second index corresponding to an exemptions list using the hybrid search model. In some embodiments, the search workflow can be configured to perform a single search use case. In other embodiments, the search workflow can be configured to perform one or more search use cases.

In some embodiments, the context module 124, based on the search workflow configured by the user, can obtain data for each of the search use cases from one or more sources including, for example and without limitation, the data module 122, the data sources of data source 104 or some other data source, the results output by a previous search use case, external data sources, or any combination thereof. In some embodiments, the context module 124 can also perform one or more processing operations on the data from the one or more data sources prior to being utilized in the one or more search use cases.

According to some embodiments, the context module 124 can build one or more indexes, each index having data entries corresponding to names of individuals or entities from at least one of the one or more data sources. The one or more indexes can include an index having data entries from at least one of the sanctions watchlist data, the sanctions adjudication data, the merchant data, the user data, or any combination thereof. In some embodiments, the one or more indexes can include an index having data entries from the sanctions watchlist data. In some embodiments, the one or more indexes can include an index having data entries from the sanctions adjudication data. In some embodiments, the one or more indexes can include an index of data entries from the user data. In some embodiments, the one or more indexes can include an index of data entries from the merchant data.

In some embodiments, the context module 124 can include an embedding model. The context module 124 can transform the data from the one or more data sources into a vector database including embedding vectors representative of the data mapped in a multi-dimensional vector space using the embedding model. In some embodiments, the embedding vectors in the vector database can correspond to the data in the indexes. In some embodiments, the context module 124 can also transform other data into embedding vectors including, but not limited to, input data associated with the transaction, match results output by the first model, other data, or any combination thereof.

According to some embodiments, the context module 124 can provide one or more search configuration parameters for identifying a match between the user input and the one or more indexes by implementing one or more search techniques using at least one of a first model or a second model (or a first model portion 126a and a second model portion 126b) of the search module 126, as will be further described herein.

In some embodiments, the screening system 102 can include a search module 126. In some embodiments, the search module 126 can include a search model (shown as a first model portion 126a and a second model portion 126b). The search model can also be referred to herein as a hybrid search model. The search module 126 can leverage the first model portion 126a to identify matches between the user inputs and the one or more indexes by applying one or more techniques including the keyword-based search techniques. The search module 126 can leverage the second model portion 126b to identify matches between embedding vectors representative of the user inputs and a vector database representative of the one or more lists. In other embodiments, the search module 126 can include a first model and the second model, the first model corresponding to the first model portion 126a and the second model corresponding to the second model portion 126b.

In some embodiments, the first model portion 126a and the second model portion 126b can be applied independent of each other. For example, a search workflow can be configured by a user including a first use case to identify a first match between a first user input and an index using the first model portion 126a, a second use case to identify a second match between a second user input and a vector database using the second model portion 126b, and a third use case to obtain and consolidate the first match and the second match, where at least a portion of the second user input can be different from the first user input, and where at least a portion of the data in the vector database can be different from the data in the index. In other embodiments, the first model portion 126a and the second model portion 126b can be sequentially applied. For example, a search workflow can be configured by a user including at least a first use case to identify a first set of matches using the first model and identify a second set of matches using the second model, where at least a portion of the input applied to the second model is from the first set of matches output by the first model.

In some embodiments, the search module 126 can utilize the first model portion 126a to identify matches between the user input and the data entries from the one or more indexes using one or more search techniques. In some embodiments, the user input can include one or more user inputs. In some embodiments, the user input can include one or more fields. In some embodiments, each field of the user input can be a text field including letters and words. The first model portion 126a can identify matches between the user inputs and the one or more indexes based on the letters and words from the user input and the data entries from the one or more indexes. In some embodiments, the user input can include an entity name. In some embodiments, the user input can include, for example and without limitation, personal names, item details, location data, language data, device data, user behavior data, historical user data, or other elements associated with the transaction.

In some embodiments, the search module 126 can utilize the second model portion 126b to identify matches between the user input and a vector database representative of the data entries in the lists from the one or more data sources. Similar to the user input for the first model, the user input can include one or more user inputs and can include one or more fields. In some embodiments, for the second model portion 126b, the user inputs can be transformed into embedding vectors having values based on the context. In some embodiments, the user input can include, for example and without limitation, personal names, item details, location data, language data, device data, user behavior data, historical user data, or other elements associated with the transaction. In some embodiments, the results output from the first model portion 126a can be applied as inputs to the second model portion 126b as transformed embedding vectors.

According to some embodiments, the second model portion 126b can identify matches between the embedding vectors representative of the user inputs and the vector database based on having a shared meaning according to the semantic context of the embedding vectors. The second model portion 126b can utilize one or more techniques for identifying a semantic similarity between vectors according to their value, which may not be identifiable by the first model due to the text strings being lexically dissimilar from each other. Accordingly, in some embodiments, the search module 126 can improve the matches identified by the first model portion 126a with the matches identified by the second model portion 126b to provide an improved set of results that doesn't only reflect lexically similar words and abbreviations from a transaction or user input but can also capture the underlying meaning of the transaction or user input.

In some embodiments, the first search model portion 126a can include one or more parameters configured for the first model portion 126a to identify a full or partial match between a query string from a user input and strings representative of entries in an index. The search module 126 can utilize the first model portion 126a to identify potential matches based on the query string being a full or partial match to a respective entry in the one or more indexes. In some embodiments, for each match, the first model portion 126a can provide a model score representative of the probability that the user input corresponding to the query string is a match to the respective entry from the indexes. In some embodiments, the higher the model score, the higher the probability that the query string is a match to the string from the indexes.

The first model portion 126a may not, however, be optimally configured to identify a potential match between a query string and the index in instances when the query string does not match a full or partial string from the index. For example, the entity name from the user input being misspelled by the user can result in a slight mismatch that may produce a false negative because the query string does not match a full or partial string in the index. Accordingly, in some embodiments, the search module 126 can utilize the first model portion 126a to identify potential matches between the query string and the one or more indexes using one or more other search techniques. The one or more other search techniques of the first model can include, for example and without limitation, phonetic search, connected search, free text matching, other search techniques, or any combination thereof. The search module 126 can thereby utilize the first model portion 126a having one or more parameters configured by the context module 124 to identify matches that may not be full or partial matches between the query string and the entries in the one or more indexes using one or more other search techniques. For example, the first model portion 126a may identify a potential match based on a phonetic similarity between the query string and the string from the indexes using a phonetic search technique. For example, the first model portion 126a may identify a potential match based on determining the query string is a malformed or non-traditional spelling of the string from the indexes using a free text matching technique.

In some embodiments, the search module 126 can utilize the second model portion 126b to identify potential matches between the embedding vectors representative of the user input and the embedding vectors from a vectors database representative of the data from the one or more data sources based on their semantic similarity. In some embodiments, the second model portion 126b can have one or more parameters configured by the context module 124 to employ vector-based search techniques to identify a match based on the proximity of the data and query points in a multi-dimensional vector space to perform a semantic search. In some embodiments, the second model portion 126b can include an embedding model to transform an input data into embedding vectors so that the second model portion 126b can perform a vector search and identify potential matches between the embedding vectors representative of the input data and the embedding vectors from the vector database in the multi-dimensional vector space. For example, the search module 126 can provide the second model portion 126b to identify potential matches representative of a semantic similarity between the embedding vectors representative of the user input and data entries by applying a k-nearest neighbor algorithm to the data to identify the k most similar data points (i.e., vectors) to a given query vector based on their proximity in the multi-dimensional vector space, the second model portion 126b thereby determining the semantic similarity between the user input and the vector database based on the nearest neighbors of the corresponding embeddings. It is to be appreciated that the second model portion 126b can identify potential matches between the embeddings representative of a user input and the vector database by application of one or more other algorithms including, for example and without limitation, clustering algorithms, decision-tree algorithms, or other embedding vector semantic search algorithms.

According to some embodiments, the second model portion 126b can transform text (i.e., string of text) into embedding vectors having values representative of the semantic meaning. In some embodiments, the embeddings can include, for example and without limitation, word embeddings, sentence embeddings, paragraph embeddings, or any combination thereof. The second model portion 126b can, based on the word embeddings, understand a meaning of a word. For example, the second model portion 126b can transform a substring of text for a word into word embeddings having vector values representative of a meaning of the word. The second model portion 126b can, based on the sentence embeddings, understand a meaning of a sentence or phrase. For example, in some embodiments, the second model portion 126b can transform a string of text for a phrase or sentence into a sentence embedding having vector values representative of a meaning of the sentence. In addition, the second model portion 126b can understand a meaning of a paragraph or group of sentences based on the paragraph embeddings.

In some embodiments, the second model portion 126b can be capable of distinguishing between entity names from the user input and the vector database even if a portion of the entity name may be semantically similar. For example, the second model portion 126b may be able to determine that two entities, “Trees Limited” and “Plants Limited,” are different entities based on the word embeddings and the sentence embeddings. In this regard, in some embodiments, the second model portion 126b can average out the results of the word embeddings, which are agnostic in order, utilizing the sentence embeddings, which thereby can allow the search model of the search module 126 to be more generalized for a broad range of different applications rather than being limited to a certain field or category. In some embodiments, the search model of the search module 126 can thereby improve upon the limitations of conventional semantic models which utilizes an approach that is agnostic to word order and that exhibits a higher relative likelihood to generate false positives for semantically similar entity names such as is provided in the example above, whereas the search model of the search module 126 of the present disclosure can be a hybrid search model that exhibits improved performance in distinguishing between entity names when identifying matches and can reduce a number of false positives.

According to some embodiments, the search model of the search module 126 can generate a match score representative of the similarity between a user input and a data entry from the vector database, which includes data that can correspond to one or more of the indexes. In some embodiments, the match score can have a range from 0 to 100. In some embodiments, the match score can be representative of the degree of similarity between the data points as determined by the search model of the search module 126. In some embodiments, for example, a higher relative match score generated by the second model portion 126b can be indicative of two data points or substrings being more similar than if the second model were to generate a lower relative match score. In other embodiments, if the match score of the user input is above a certain threshold limit, the screening system 102 can perform some additional actions. In some embodiments, the screening system 102 can flag the account for further investigation.

It is to be appreciated, however, that the range of the match score is not intended to be limiting and can include a range of 0 to 100 and other ranges as can be appreciated by those skilled in the art. In some embodiments, the hybrid search model of the search module 126 can identify matches between a user input and one or more indexes using the first model portion 126a, and the first model portion 126a can generate match scores indicative of the match quality for each of the identified matches. In other embodiments, the hybrid search model can identify matches between a user input and one or more vector databases using the second model portion 126b, and the second model portion 126b can generate match scores indicative of the match quality for each of the identified matches. In some embodiments, the match scores generated by the second model portion 126b may be based on the match score associated with the input obtained from the first model portion 126a.

According to some embodiments, the search module 126 can include an embedding model. In some embodiments, the search module 126 can utilize the embedding model to transform data into embedding vectors having values representative of their meaning based on the context. Accordingly, in some embodiments, the same data point (e.g., word) can be represented by different vector representations based on the context. In some embodiments, the second model portion 126b can include the embedding model. In other embodiments, the search module 126 can include a first model portion 126a, a second model portion 126b, and an embedding model portion.

By utilizing the embeddings model, the search module 126 improves upon conventional approaches that only utilizes a keyword-based approach including those that utilize manually populated lists of similar terms to identify matches. These conventional approaches are limited, however, because it is difficult and time-consuming to manually populate these lists, such lists are brittle and cannot identify matches for terms not in the lists, and manually comparing similar terms is generally ineffective because terms can have different meanings depending on their context, which a simple keyword-based search methodology does not capture.

In addition, by utilizing the embeddings model, the search model 126 can improve upon other known approaches that utilize manually populated lists of abbreviations. These other known approaches are limited, however, for similar reasons because of the wide variety of different possible abbreviations that can be utilized to represent a term, and because such manually populated lists used by these other known approaches are brittle and cannot identify matches from abbreviations that are not in the lists, and because abbreviations can have different meanings in different contexts. In some embodiments, the semantic search capability of the second model portion 126b of the search module 126 overcomes the limitations of these other known approaches and other associated limitations by utilizing a vector-based search methodology that can understand the different meanings of terms based on their context, which thereby reduces false positive matches and improves true positive matches.

The hybrid search model of the search module 126 also improves upon limitations of other conventional approaches that utilize only a semantic search methodology. These conventional approaches are limited because vector-based searches can demonstrate decreased performance on closed domain information that is not widely known or public (e.g., not accessible on the internet), which can cause issues when matching niche acronyms or other situations where a keyword-based search approach may demonstrate better results.

There are also instances when the keyword-based approach can exhibit better performance over vector-based search approaches for certain text strings. Other vector-based search methodologies can also require additional finetuning on domains that it is not familiar with, as the embedding model is tuned for different applications. However, the embodiments of the present disclosure can improve upon the limitations of these conventional approaches by being finetuned using a training dataset that can better align the application of the second model for identification of a semantic similarity between a user input from a transaction and entries from one or more data sources.

According to some embodiments, the search module 126 can train the search model using a training dataset. The search module 126 can train the search model using one or more datasets including, for example and without limitation, watchlist data, sanction adjudication data, or other types of data. For example, the search model can be trained using the sanction adjudication data to learn what is considered false positive matches and/or the reasons why it is a false positive result by updating, for example, one or more layers of the model using the training data as can be appreciated by skilled persons. In some embodiments, the search module 126 can train the first model portion 126a using a training dataset. In some embodiments, the search module 126 can train the second model portion 126b using the training dataset.

In some embodiments, the trained model can then be utilized to perform searches and to identify matches with improved decision making capability of whether the potential match is relevant or not. For example, the trained second model portion 126b can be applied to the match results generated using the keyword-based search techniques of the trained first model portion 126a to remove any false positive matches identified based on the training.

In some embodiments, In some embodiments, screening system 102 includes a result consolidation module 128. In some embodiments, the result consolidation module 128 can obtain the results from the search use cases of the search workflow and can perform some additional processing steps, processes, methods, operations, etc. For example, the result consolidation module 128 can obtain results from a first use case and a second use case and perform some additional processing to the obtained results prior to the screening system 102 taking some action (e.g., generate a flag of a transaction), according to some embodiments. In some embodiments, the search workflow configuration can define a plurality of use cases, and the result consolidation module 128 can obtain the outputs from one or more of the plurality of use cases and process the obtained results.

In some embodiments, the result consolidation module 128 can obtain and finetune the results from the search use cases. In some embodiments, the result consolidation module 128 can process the data obtained from the use cases according to one or more conditions defined in the workflow configuration. The one or more conditions of the search configuration can be obtained by the result consolidation module 128 from the context module 124. In some embodiments, the result consolidation module 128 can remove any duplicate or overlapping results. For example, the result consolidation module 128 can obtain a first set of results from a first index based on a first set of user inputs matching a first index, the result consolidation module 128 can obtain a second set of results from a second use case based on a second set of user inputs matching a second index, and the result consolidation module 128 can finetune the data by removing one or more of the user inputs from the first set of results that resulted in a match according to the second set of results. In this example, at least one of the second set of user inputs at the second use case includes at least one result from the first set of results, such that the second use case can then identify a match between the second set of inputs and the second index, in some embodiments.

Various embodiments herein can employ artificial-intelligence, neural network models, deep learning neural network models, deep q-learning neural network models, and/or machine learning systems and techniques to facilitate training the models or model portions from scratch, training the models using audit data, training the models using feedback data (e.g., sanctions adjudication data), training the models using reinforcement learning for continual learning, determining decisions as output predictions based on applying the input data to the models, determining decisions as output predictions based on applying an output prediction from another model as input data, other processes, or any combination thereof. Although the one or more embodiments are described in the present disclosure in the context of determining matches for client inputs as compared to one or more datasets (i.e., indexes or vector databases) for transactions in the transaction processing system 106, the one or more embodiments can be applied to services at a domain in the context of electronic transactions or other electronic activity.

It can therefore be appreciated that the various embodiments can be utilized in a networked system such as, for example, system 100 for any of a plurality of purposes including, but not limited to, fulfilling transactions, authentications, content recommendations, managing threats including identifying suspicious or fraudulent transactions, learning user behavior, context-based scenarios, preferences, etc. in order to facilitate the system 100 taking automated action with high degrees of confidence for the computing devices performing transactions on the network 112. Utility-based analysis can be utilized to factor benefit of taking an action against cost of taking an incorrect action. Probabilistic or statistical-based analyses can be employed in connection with the foregoing and/or the following.

It is noted that systems and/or associated controllers, servers, or M.L. components herein such as discussed above in context of search module 126 and the other functional modules of screening system 102 in FIG. 1 can include artificial intelligence component(s) which can employ an artificial intelligence (AI) model, neural network or a neural network model, or a M.L. model, that can learn to perform the above or below described functions (e.g., via training data and/or feedback data). In some embodiments, the screening system 102 can include a machine learning model configured to utilize natural language processing (NLP) to determine a context of user inputs and data entries in datasets based on text data. In other embodiments, the screening system 102 can include a machine learning model configured to utilize one or more techniques to determine a context of a user input from a transaction or a context of a data entry in a dataset (e.g., sanctions list) based on text data, image data, sequential data, other types of data, or any combination thereof. In some embodiments, the model can include, for example, a small language model, medium language model, large language model.

In some embodiments, the system 100 and/or the screening system 102 can include an M.L. module including an A.I. and/or M.L. model that can be trained (e.g., via supervised and/or unsupervised techniques) to perform one or more of the above or below-described functions using training data including various context conditions that correspond to various management operations. In one example, an A.I. and/or M.L. model can further learn (e.g., via supervised and/or unsupervised techniques) to perform the above or below-described functions using training data including feedback data, where such feedback data can be collected and/or stored (e.g., memory 116 or datastore 104) by search module 126, or data module 122, or by an M.L. component of screening system 102. In this example, such feedback data can include the various instructions described above/below that can be input, for instance, to a system herein, over time in response to observed/stored context-based information.

A.I./M.L. components herein can initiate an operation(s) associated with the one or more functional modules 120, 122, 124, 126, 128 of the screening system 102 based on a defined level of confidence determined using information (e.g., feedback data). For example, based on learning to perform such functions described above using feedback data, performance information, and/or past performance information herein, an M.L. model herein can initiate an operation associated with providing decisions or match scores as output predictions determined based on the input data applied to the model including context data from the service request (e.g., search workflow) including, but not limited to, user data, account data, device data, historical data, inventory data, user behavior data, sequence data, other types of data at screening system 102 or transaction processing system 106, or any combination thereof. In another example, based on learning to perform such functions described above using feedback data, an M.L. model can be trained from scratch, trained using reinforcement learning, trained using continual learning, or trained using data based on the activity of the services at the domain.

In an embodiment, the M.L. model can perform a utility-based analysis that factors cost of initiating the above-described operations versus benefit. In this embodiment, an artificial intelligence component can use one or more additional context conditions to determine an appropriate distance threshold or context information, or to determine an update for a tuning model.

To facilitate the above-described functions, an M.L. model herein can perform transformations, classifications, correlations, inferences, and/or expressions associated with principles of artificial intelligence. For instance, an M.L. model can employ an automatic classification system and/or an automatic classification. In one example, the M.L. model can employ a probabilistic and/or statistical-based analysis (e.g., factoring into the analysis utilities and costs) to learn and/or generate inferences. The M.L. model can employ any suitable machine-learning based techniques, statistical-based techniques and/or probabilistic-based techniques. For example, the M.L. model can employ expert systems, fuzzy logic, support vector machines (SVMs), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or the like. In another example, the M.L. model can perform a set of machine-learning computations.

For instance, the M.L. model can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

In some embodiments, the M.L. model can utilize one or more matching techniques based on the letters and words of an input including, but not limited to, keyword-based matching, phonetic matching, connected matching, free text matching, or any combination thereof. In some embodiments, the M.L. model can utilize one or more matching algorithms based on the meaning of the inputs and their context including, but not limited to, a k-nearest neighbor algorithm. In some embodiments, the M.L. model can utilize one or more clustering techniques including, but not limited to, density-based clustering, distribution-based clustering, centroid-based clustering, hierarchical based clustering, or any combinations thereof. In addition, the one or more models can apply one or more clustering algorithms including, but not limited to, k-means clustering algorithms, density-based clustering algorithms, Gaussian mixture model algorithms, balanced iterative reducing and clustering using hierarchies (BIRCH) algorithms, propagation clustering algorithms, mean-shift clustering algorithms, order point clustering, agglomerative hierarchy clustering algorithms, other algorithms, or any combinations thereof. For example, the model can apply the one or more centroid-based clustering models to determine clusters using k-means clustering algorithms.

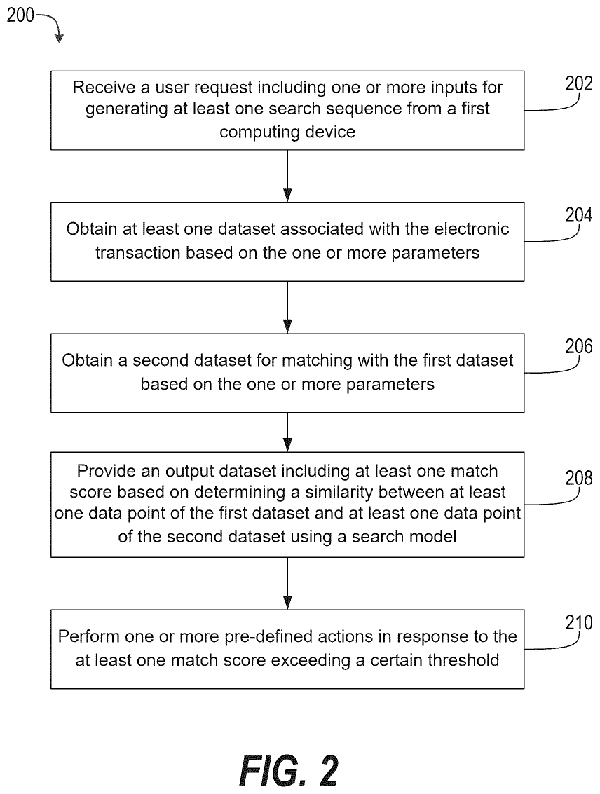

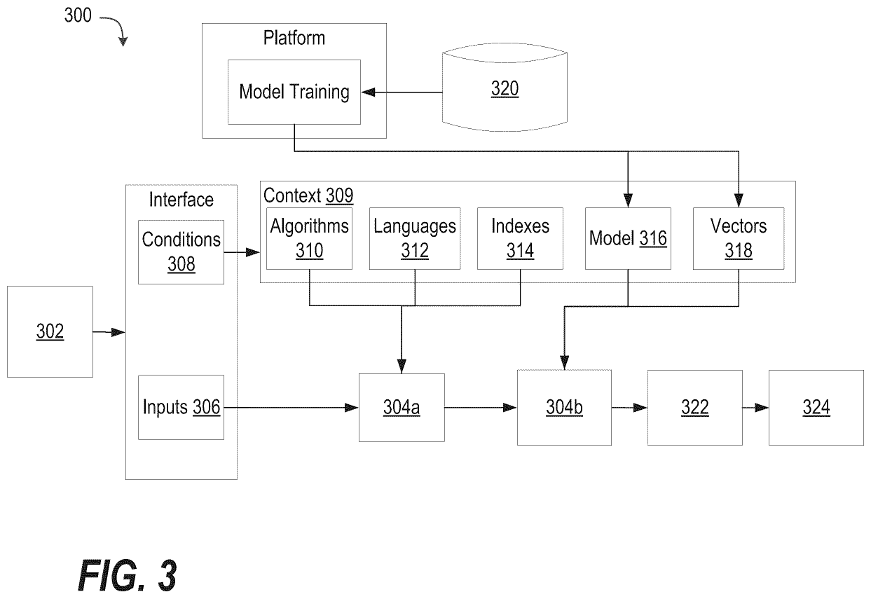

FIG. 2 is a flow diagram of an example method 200 for screening the user inputs, according to some embodiments. The method 200, or one or more portions of the method 200, can be performed by the screening system 102 in conjunction with transaction processing system 106, and thus may be computer-implemented. FIG. 3 is a block diagram of an example system 300 for screening the user inputs, according to some embodiments. The system 300 can be an embodiment of screening system 102 of FIG. 1. The method 200 will be described in conjunction with system 300.

At 202, the method 200 can include receiving a user request including one or more inputs for generating at least one search sequence from a first computing device. In FIG. 3, the first computing device is shown at block 302, the user request including the one or more inputs is shown at interface 303 including one or more elements including inputs 306 and conditions 308, and the at least one search sequence is shown including a first search use case at block 304a and a second search use case at block 304b. It is to be appreciated that although FIG. 3 shows the at least one search sequence as including the first search use case at block 304a and the second search use case at block 304b, this is exemplary and not intended to be limiting, and the at least one search sequence, and include one, two, three, four, or more search use cases as defined according to the one or more inputs of the user request.

The user request can be received from a user of the first computing device. In some embodiments, the user request can be received from a user associated with one of a plurality of first computing devices. For example, the user of the first computing device can be a data scientist associated with an entity that provides the user request to configure the parameters of at least one search sequence by a screening system such as, for example, the screening system 102 of FIG. 1.

In some embodiments, the first computing device can be associated with a computing system or networked computing environment of an entity such as, for example, system 100 of FIG. 1, and including a screening system such as, for example, screening system 102 of FIG. 1, to perform the user account screenings. In some embodiments, the first computing device can be associated with a user that is associated with the entity. For example, the user can be a data scientist associated with an entity, and the entity can provide a system including the transaction processing system and the screening system that operates in conjunction with a transaction processing system.

In some embodiments, the user request can be received from the first computing device. The user request can include the one or more inputs. In some embodiments, the one or more inputs of the user request can define a search condition parameters of a screening workflow to be performed using a screening system of a computing system associated with an entity. In some embodiments, the one or more inputs can define, for example and without limitation, a context for a search sequence, input fields, search conditions, pre search conditions, result consolidation conditions, other parameters, or any combination thereof. For example, the search sequence can be one of a plurality of categories of search sequences determined based on the context. In FIG. 3, the search condition parameters is shown as conditions 308.

In some embodiments, the one or more inputs of the user request can define the at least one search sequence to be performed by a screening system associated with the entity. In some embodiments, the user request can define a single search sequence to be performed by the screening system. In other embodiments, the user request can define a plurality of search sequences to be performed by the screening system. In some embodiments, the user request can be input by the user at an electronic user interface provided to the user computing device. In FIG. 3, the inputs 306 includes the definitions for the at least one search sequence.

In some embodiments, the one or more inputs of the user request can define one or more input fields for the at least one search sequence. In some embodiments, the input field can include a text string representative of one or more words, sentences, or paragraphs, according to the input. In some embodiments, the one or more input fields can be associated with an electronic transaction. For example, the one or more input fields can be names of a source entity and a target entity. In some embodiments, the input field can be from an electronic document. In other embodiments, the input field can be from one or more electronic documents. For example, when a user initiates an electronic transaction, an electronic document can be generated including the labeled users inputs, and the one or more input fields defined in the user query can be obtained from the electronic document. In FIG. 3, the one or more input fields is shown at inputs 306.

In some embodiments, the input fields can be obtained from a second computing device of a second user, the input fields being defined based on the one or more user inputs of the user request from the first computing device. In some embodiments, the input fields can be associated with, for example, an electronic transaction requested to be performed at a transaction processing system by a user of the second computing device, the input fields being obtained based on user inputs from the user associated with the second computing device. For example, the one or more inputs of the user request can define an “x,” “y,” and “z” input fields to obtain for a search sequence, the input fields associated with aa requested electronic transaction request from the second computing device. In some embodiments, the input fields can be from an output of another search sequence (e.g., use case) of the search workflow. In this regard, in some embodiments, the user request can define a plurality of search sequences, and the input to a particular search sequence can include one or more inputs, and the one or more inputs can include data output by another sequence. For example, a search sequence can receive a text string and a match score as inputs from another search sequence based on the other search sequence determining that the text string is a full or partial match to a data entry in an index. In FIG. 3, the input fields defined by the one or more user inputs is shown as block 306.

In some embodiments, the one or more inputs of the user request can define the search conditions. The search conditions can define parameters of the at least one search sequence including, but not limited to, the search model parameters, model algorithm parameters, languages including default language and translation language, indexes to be utilized to fulfill the workflow, vector datasets to be utilized to fulfill the workflow, other parameters, or any combination thereof. In FIG. 3, the search condition parameters is shown as conditions 308.

In some embodiments, the search condition parameters of the user request obtained from the first computing device can define a context for the workflow to be performed by the at least one search sequence. In some embodiments, the context can include one or more elements including, but not limited to, algorithm parameters, language parameters, index parameters, embedding model parameters, vector dataset parameters, other parameters, or any combination thereof. In FIG. 3, the context for the at least one search sequence of the workflow is shown context 309 and includes algorithms 310, languages 312, indexes 314, model 316, and vectors 318.

In some embodiments, the search conditions can define an algorithm to be utilized by the search model. In some embodiments, the search conditions can also define parameters of at least one of a first model portion or a second model portion of the search model to be utilized for the at least one search sequence. In some embodiments, the search conditions can define one or more algorithms to be utilized by the first model portion of the search model. In some embodiments, the search conditions can define one or more algorithms to be utilized by the second model portion of the search model.

In some embodiments, the search conditions can define one or more language parameters. In some embodiments, the language parameters can include a default language associated with an electronic transaction. For example, the user account of the user associated with the electronic transaction can include a default language setting. In some embodiments, the language parameters can also include a translation language. For example, the user inputs associated with the electronic transaction can be in a first language, the index to be searched by the search sequence can be in a second language, and the search conditions can identify the respective languages to enable the identification of matches between the user inputs and the index.

In some embodiments, the search conditions can define an index for the search sequence. In some embodiments, the index can include a set of data entries and each data entry can include one or more text strings. In some embodiments, a text string can be representative of one or more words of a data entry. For example, an entity name can include one or more words represented by a text string. In some embodiments, the data entry can be partitioned into one or more text strings. For example, an entity name can include one or more words, and each word can be represented by a text string.

The index can be obtained from a data source. In some embodiments, the index can be obtained from one or more data sources. For example, the data sources can include a sanctions list and a sanctions adjudication list. In some embodiments, the search conditions can define one or more indexes to be utilized by the search sequence, and each index can correspond to a list of data entries from at least one of the data sources. In FIG. 3, the data source is shown as data source 320.

In some embodiments, the search conditions can define a vector dataset or a vector database for the search sequence. In some embodiments, the vector dataset can include a set of embeddings and each data entry can include one or more embeddings having vector values representative of the data entry. In some embodiments, the set of embeddings can include character embeddings, word embeddings, sentence embeddings, paragraph embeddings, or any combination thereof. In some embodiments, the embeddings vectors can include one or more character embeddings representative of a meaning of a word. In some embodiments, the embeddings vectors can include one or more word embeddings representative of a meaning of one or more words. In some embodiments, the embeddings vectors can include one or more sentence embeddings representative of a meaning of a group of sentences or a paragraph. In some embodiments, the embeddings vectors can include one or more paragraph embeddings representative of a meaning of one or more paragraphs or an electronic document. For example, the electronic document can be representative of an item associated with the electronic transaction.

In some embodiments, the vector dataset can be obtained from the data source. In some embodiments, the vector dataset can be obtained from one or more data sources. In some embodiments, the search conditions can define an index for the search sequence, and the text strings of the index can be transformed into embedding vectors of a vector dataset using an embedding model. In some embodiments, one or more of the embedding vectors can be representative of a context of, for example, a word in a group of words. For example, one or more of the embedding vectors representative of a word can be based on a context of the word relative one or more other words of the data entry. In some embodiments, the search conditions can define one or more indexes to be utilized by a search sequence, and the text strings of each of the one or more indexes can be transformed into embedding vectors of a vector dataset using the embedding model for the search sequence.

It is to be appreciated that although FIG. 3 shows the context elements defined by the search condition parameters include blocks 310, 312, 314, 316, 318, the context elements of FIG. 3 are exemplary and not intended to be limiting, and that the context elements can include the elements shown at blocks 310, 312, 314, 316, 318, other elements, or any combination thereof, as defined according to the user request such that the screening workflow can fulfill the at least one search sequence of the user request. For example, the search conditions may not include the languages 312 context parameters because the input fields and the data from the data sources use a common language.

At 204, the method 200 can include obtaining, for the at least one search sequence, a first dataset associated with the electronic transaction based on the one or more parameters. In some embodiments, each data point of the first dataset includes a user input obtained from a second computing device. In some embodiments, the first dataset includes one or more user input fields obtained from the second computing device. In some embodiments, each user input field of the first dataset can be an entity name associated with the electronic transaction. In some embodiments, the one or more entities names can be determined from the one or more user inputs obtained from the second computing device. For example, the entity names can include a source entity or individual and a target entity or individual associated with an electronic transaction. In FIG. 3, the search sequence 304a can include the first dataset, and is first dataset is defined from inputs 306.

According to some embodiments, the first dataset can further include other data associated with a user of the second computing device. In some embodiments, the first dataset can include at least one of account data, personal data, device data, location data, language data, user behavior data, or any combination thereof. In some embodiments, this other data can be utilized by the at least one search sequence to determine a match between the first dataset and the second dataset. For example, the user inputs can be in a first language and the data entries of the second dataset can be in a second language, and the at least one search sequence can translate the user inputs of the first dataset in the first language to the second language of the second dataset.

At 206, the method 200 can include obtaining, for the at least one search sequence, a second dataset for matching with the first dataset based on the one or more parameters. In some embodiments, the second dataset can include a plurality of entities names obtained from one or more data sources. In some embodiments, the at least one search sequence can include determining whether a user input matches with any of the plurality of entities names of the second dataset. In some embodiments, the second dataset can include at least one of an index or a vector database. In some embodiments, the second dataset can include an index, and the at least one search sequence can determine whether a text string of the user input matches with any of the plurality of data entries of the index. In other embodiments, the second dataset can include one or more indexes, In some embodiments, the second dataset can include a vector dataset, and the at least one search sequence can determine whether the embeddings representative of the user input matches with the embeddings representative of the data entries of the vector dataset. In FIG. 3, the search sequence 304b can include the second dataset, and the second dataset is defined from inputs 306.

In some embodiments, the one or more data sources can include data corresponding to one or more lists from one or more categories. In some embodiments, the second dataset can include one of the lists from the one or more data sources. In some embodiments, the second dataset can include a plurality of lists from different categories from the one or more data sources. In some embodiments, the second dataset can include a plurality of lists from one of the categories. In some embodiments, the one or more data sources can include at least one of a sanctions list, a sanctions adjudication list, or a watchlist. In some embodiments, the sanctions list can correspond to, for example, entities names that have been sanctioned by a regulatory authority. In some embodiments, the sanctions adjudication list can correspond to, for example, entities names that have been reviewed according to a sanctions adjudications process. In some embodiments, the watchlist can correspond to, for example, entities names suspected of malicious electronic activity in a data processing system associated with a system of an entity. In some embodiments, the entities names of the watchlist can be identified from, for example, user complaints, social media posts, emails, voice logs, video data, images, or other sources, which has been identified by users of, for example, the transaction processing system 106 in FIG. 1. For example, the index can include one or more entities names from the sanctions list. In other embodiments, the entities names of the watchlist can be suspected of malicious electronic activity in another system external to a system of the entity. The one or more data sources is shown at data source 320 in FIG. 3.

At 208, the method 200 can include providing, for the at least one search sequence, an output dataset including at least one match score based on determining a similarity between at least one data point of the first dataset and at least one data point of the second dataset using a search model. In some embodiments, the output dataset can include one or more entities names of the first dataset and a corresponding set of match scores determined by the at least one search sequence as matching the second dataset. The output dataset is shown as block 322 in FIG. 3.

At 210, the method 200 can include performing one or more pre-defined actions in response to the at least one match score exceeding a certain threshold. The at least one match score exceeding the certain threshold is indicative of a positive match between the first dataset and the second dataset. The pre-defined actions is shown as block 324 in FIG. 3.

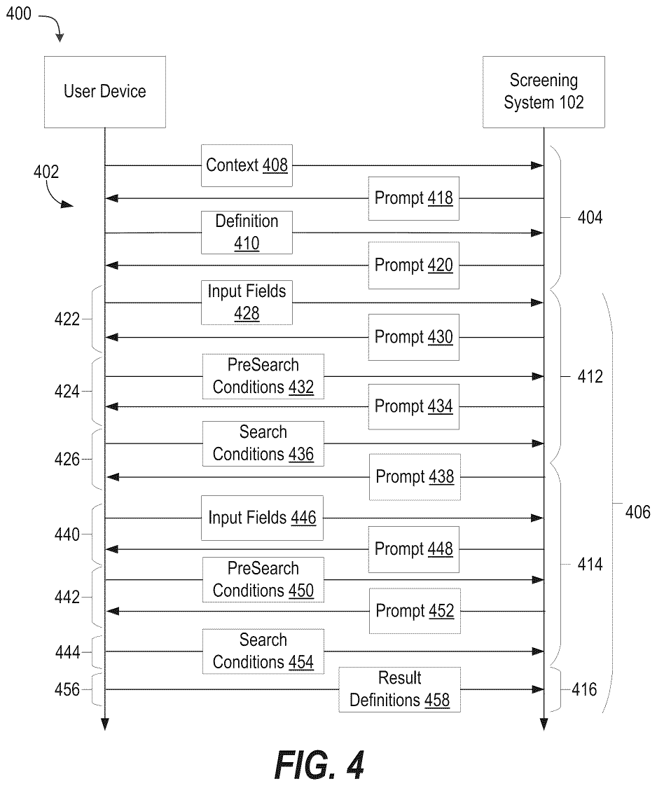

FIG. 4 is a flow diagram of an example system 400 performing a search query 402, according to some embodiments. The search query 402, or one or more portions of the search query 402, can be performed by screening system 102 in conjunction with transaction processing system 106, and thus may be computer-implemented.

According to some embodiments, the search query 402 can be obtained from a computing device. In some embodiments, the user device can be, for example, a first computing device as described with regards to FIG. 2, from a user associated with an entity associated with the screening system 102. The search query 402 can be received from the user device via a user interface, and the search query 402 can include one or more inputs from a user of the user device. In some embodiments, the one or more inputs at the user interface can include, but is not limited to, text data, user click data, user interaction data, or any combination thereof, provided by the user of the user device.

In some embodiments, the search query 402 can include an initiation phase 404 and one or more search sequences 406. In some embodiments, the initiation phase 404 can include a context 408 and definitions 410 for the one or more search sequences 406. In some embodiments, the context 408 can specify a type of screening to be performed. In some embodiments, the definitions 410 can define the steps to be performed in a screening workflow, which includes the one or more search sequences 406. For example, the context 408 can define that the at least one search sequence 406 is a sanctions screening, for identifying a match between one or more user inputs and a sanctions list.

In some embodiments, the one or more search sequences 406 defined by the search query 402 can include a first search sequence 412, a second search sequence 414, and a third search sequence 416, according to some embodiments. It is to be appreciated that the at least one search sequence 406 is not intended to be limited to including the first search sequence 412, the second search sequence 414, and third search sequence 416, but can include more search sequences or less search sequences as configured according to the user inputs.

In the initiation phase 404 of the search query 402, the screening system 102 can provide one or more prompts to the user computing device, such that the one or more search sequences can be configured by the user of the user computing device. In some embodiments, the screening system 102 can provide a prompt 418 in response to the context 408. For example, the prompt 418 can be a request for inputs detailing the steps involved in the one or more search sequences 406. In some embodiments, the screening system 102 can provide a prompt 420 in response to the definitions 410. For example, the prompt 420 can be a request for inputs detailing the parameters of the one or more search sequences 406.

In some embodiments, the search query 402 can include one or more definitions for the first search sequence 412. In some embodiments, the first search sequence 412 can include an input portion 422, a pre search portion 424, and a search portion 426.

In some embodiments, in the input portion 422, the search query 402 can include a user input defining one or more input fields 428 to be obtained for one or more other portions of the first search sequence 412, and which can be compared to the second dataset from the one or more data sources. For example, the one or more input fields 428 can include user inputs “x,” “y,” and “z” from a user of the second computing device requesting initiating of an electronic transaction with one or more other users (i.e., other individuals or entities) in transaction processing system 106 of FIG. 1. In some embodiments, the screening system 102 can provide a prompt 430 in response to the user inputs of the input portion 422. For example, the prompt 430 can be a request for inputs detailing parameters of the pre search portion 424.

In some embodiments, in the pre search portion 424, the search query 402 can include a user input defining a pre search conditions 432. In some embodiments, the pre search conditions 432 can define data processing operations to be performed using the search model at the first search sequence 412. In some embodiments, the pre search conditions 432 can define one or more techniques to the applied using the search model. For example, the pre search conditions 432 can include a normalization and transformation operation to be performed on data of the first dataset and second dataset using the search model. In some embodiments, the pre search conditions 432 can define a setup request for the first search sequence 412. In some embodiments, the pre search conditions 432 can define search filters to be applied at the first search sequence 412. In some embodiments, the screening system 102 can provide a prompt 434 in response to the pre search conditions 432. For example, the prompt 434 can be a request for inputs detailing parameters of the search portion 426.

In some embodiments, in the search portion 426, the search query 402 can include a user input defining a search conditions 436. In some embodiments, the search conditions 436 can define data processing operations to be performed using the search model at the first search sequence 412. In some embodiments, the search conditions 436 can define one or more algorithms to be utilized by the search model to process the data. In some embodiments, the search conditions 436 can define one or more search algorithms to be utilized by the search model to identify matches between the user inputs associated with the electronic transaction identified from the first dataset and the second dataset. For example, the search conditions 436 can define an exact search and fuzzy search algorithms. In some embodiments, the search conditions 436 can define one or more languages to be utilized by the first search sequence 412. For example, the search conditions 436 can define a default language and a translation language. In some embodiments, the search conditions 436 can define an index to be utilized by the search model in the match identification. For example, a first model portion can determine whether the one or more user inputs of the first dataset matches with the data entries in the second dataset. In some embodiments, the search conditions 436 can define the operations to be performed in the search portion 426. For example, the search conditions 436 can define a screening operation for the first search sequence 412 to determine a match between a first (“x”) and second (“y”) input of the first dataset and an index utilizing a fuzzy search algorithm and according to a default language.

In some embodiments, the screening system 102 can provide a prompt 438 in response to the search conditions 436. For example, the prompt 434 can be a request for inputs detailing parameters of the second search sequence 414.

In some embodiments, the search query 402 can include one or more definitions for the second search sequence 414. The second search sequence 414 can include an input portion 440, a pre search portion 442, and a search portion 444.

In some embodiments, in the input portion 440, the search query 402 can include a user input defining one or more input fields 446 to be obtained for one or more other portions of the second search sequence 414. For example, the one or more input fields 446 can include user inputs “a” and “b” from a user of the second computing device requesting initiating of an electronic transaction with one or more other users (i.e., other individuals or entities) in transaction processing system 106 of FIG. 1. In some embodiments, the one or more input fields 446 can include inputs from the first search sequence 412. For example, the one or more input fields 446 can include “z” field from first search sequence 412. In some embodiments, the one or more input fields 446 can include results from the search portion 426 of the first search sequence 412 as inputs. For example, the one or more input fields 446 can include “x” and “y” search results from search portion 426 of the first search sequence 412 as “p” and “q” inputs. In some embodiments, the screening system 102 can provide a prompt 448 in response to the user inputs at the input portion 440. For example, the prompt 448 can be a request for inputs detailing parameters of the pre search portion 442.

In some embodiments, in the pre search portion 442, the search query 402 can include a user input defining a pre search conditions 450. In some embodiments, the pre search conditions 450 can define data processing operations to be performed at the second search sequence 414. In some embodiments, the pre search conditions 450 can define one or more techniques to the applied at the second search sequence 414. For example, the pre search conditions 450 can include a normalization and manipulation operations to be performed on the data from the input portion 440. In some embodiments, the pre search conditions 450 can define a setup request for the second search sequence 414. In some embodiments, the pre search conditions 450 can define search filters to be applied at the second search sequence 414. In some embodiments, the screening system 102 can provide a prompt 452 in response to the pre search conditions 450. For example, the prompt 452 can be a request for inputs detailing parameters of the search portion 444.

In some embodiments, in the search portion 444, the search query 402 can include a user input defining a search conditions 454. In some embodiments, the search conditions 454 can define data processing operations to be performed using the search model at the second search sequence 414. In some embodiments, the search conditions 454 can define one or more algorithms to be utilized by the search model to process the data. In some embodiments, the search conditions 454 can define one or more search algorithms to be utilized by the search model to identify matches between the user inputs from the one or more input fields 446 of the input portion 440. For example, the search conditions 454 can define a fuzzy search algorithm. In some embodiments, the search conditions 454 can define one or more languages to be utilized by the second search sequence 414. For example, the search conditions 454 can define a default language of a user initiating the electronic transaction. In some embodiments, the search conditions 454 can define an index to be utilized by the search model in the match identification. For example, a first model portion can determine whether the one or more user inputs of the first dataset matches with the data entries in the second dataset including an exemption index. In some embodiments, the search conditions 454 can define the operations to be performed in the search portion 444. For example, the search conditions 454 can define a screening operation for the second search sequence 414 to determine a match between a “p” input field and the exemption index utilizing an exact search algorithm and according to a default language of the user associated with the electronic transaction.

In some embodiments, the search query 402 can include one or more definitions for the third search sequence 416. For example, the third search sequence 416 can be a result consolidation sequence. In some embodiments, the third search sequence 416 can include an input portion 456. In some embodiments, in the input portion 456, the search query 402 can include a user input 458 defining parameters of the third search sequence 416. For example, the user input 458 can define a request to access search results from the first search sequence 412 and the second search sequence 414. In some embodiments, the user input 458 can define operations to be performed at the third search sequence 416. For example, the user inputs 458 can define an exemption operation to determine if input field “x” is a match to “p,” and the screening system 102 providing a decision in response to the exemption determination at the third search sequence 416.

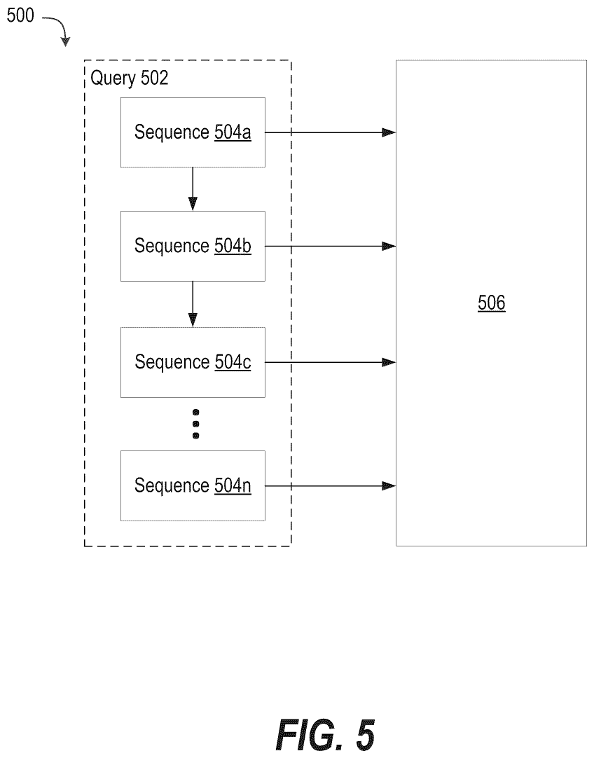

FIG. 5 is a block diagram of an example system 500 for screening the user inputs, according to some embodiments. The system 500 can be an embodiment of screening system 102, which operates in conjunction with transaction processing system 106 in system 100 of FIG. 1.

At system 500, the user query 502 from the user computing device can configure one or more search sequences 504 (shown as 504a, 504b, 504c, through 504n) to be performed at the search system such as, for example, screening system 102 of FIG. 1. In some embodiments, one or more results from a given use case can be provided as an input to another use case according to an input field definitions of the user query 502. For example, an input field “x” and a result “p” from search sequence 502a can be provided as input to search sequence 504b.

In some embodiments, one or more of the results from the one or more search sequences 504 can be received at block 506. At block 506, the system 500 can perform one or more processing operations to consolidate the results from the one or more search sequences 504 and to provide a refined set of results in response to the user query. In some embodiments, the processing operations of block 506 can include moving duplicate results. For example, the duplicate results can be removed from the set of results obtained from the one or more search sequences as described with regards to result consolidation module 128 of FIG. 1. In some embodiments, the processing operations of block 506 can include removing any results from the one or more search sequences 504 having a match score associated therewith that is below a threshold limit.

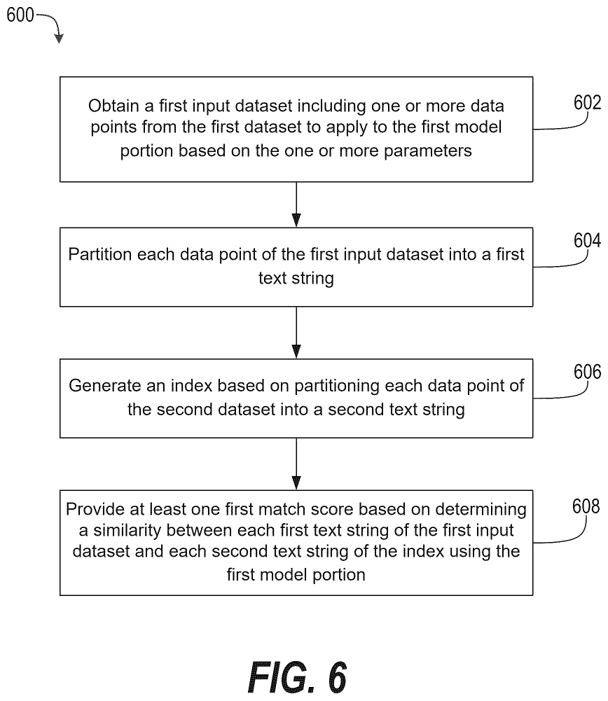

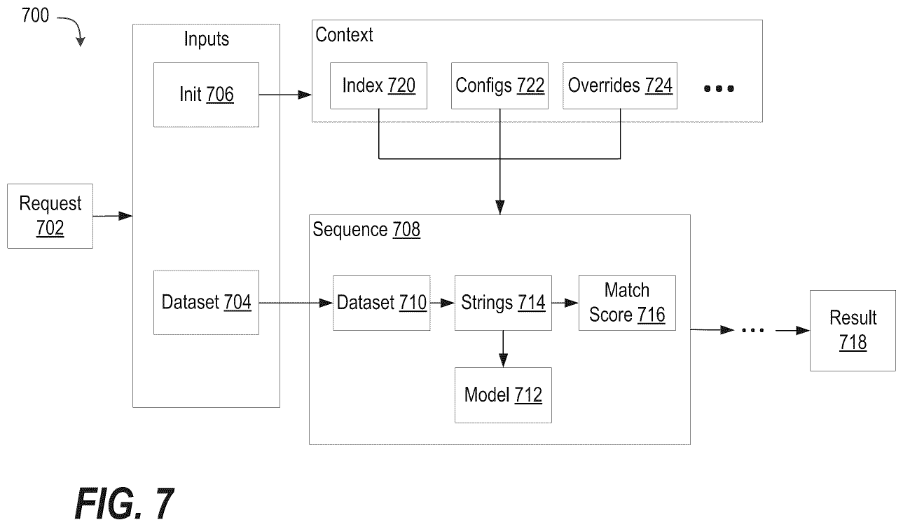

FIG. 6 is a flow diagram of an example method 600 for screening the user inputs, according to some embodiments. The method 600, or one or more portions of method 600, can be performed by screening system 102 in conjunction with transaction processing system 106, and thus can be computer-implemented. The method 600 can be an embodiment of operation 208 of method 200 of FIG. 2. FIG. 7 is a block diagram of an example system 700 for screening the user inputs, according to some embodiments. The system 700 can be an embodiment of the screening system 102 of FIG. 1. The system 700 can be an embodiment of the system 300 of FIG. 3. The system 700 can be an embodiment of the system 500 of FIG. 5. The method 600 will be described in conjunction with system 700.

According to some embodiments, the search model can include a first model portion and the determining of the similarity between the first dataset and the second dataset using the search model can include the operations of the method 600.

At 602, the method 600 can include obtaining a first input dataset including one or more data points from the first dataset to apply to the first model portion based on the one or more parameters. In some embodiments, the one or more data points can include user input fields associated with the electronic transaction being initiated by the user of the second computing device. For example, the one or more data points of the first input dataset can include a source entity name and a target entity name associated with the electronic transaction. The first dataset is shown as dataset 704, the first input dataset is shown as dataset 710, and the first model portion is shown as model 712.

At 604, the method 600 can include partitioning each data point of the first input dataset into a first text string. In some embodiments, each data point can be a word or sequence of words, and the word or sequence of words can be represented by a text string. In some embodiments, the first text string can include one or more text strings, and each word of the data point can be represented by a text string. For example, the entity name can include a first name and a second name, and the first text string can include a text string representative of the first name and a text string representative of the second name. The first text string is shown as strings 714 in FIG. 7.

At 606, the method 600 can include generating an index based on partitioning each data point of the second dataset into a second text string. In some embodiments, the second dataset can include an index having the second text string for each of a plurality of entity names from a list of entity names retrieved from the one or more data sources. The list can be one of a plurality of categories. For example, the list can be an exemptions list including entity names that are exempt from the sanctions list or some other list. The index including the second text strings is shown as index 720 in FIG. 7.

At 608, the method 600 can include providing at least one first match score based on determining a similarity between each first text string of the first input dataset and each second text string of the index using the first model portion. In some embodiments, the output dataset provided by the search sequence can include the at least one first match score determined by the first model portion. In some embodiments, the similarity can be a full match, where the first model portion determines the first text string matches one of the second text strings of the index according to an exact match algorithms. In some embodiments, the similarity can be a partial match, where the first text string matches a portion of a second text string of the index according to a fuzzy match algorithm or some other algorithms as described with regards to search module 126 of FIG. 1. In some embodiments, the first model portion can be a keyword model. In some embodiments, the first model portion can utilize at least one of an exact search algorithm or a fuzzy search algorithm to determine the similarity between the first input dataset and the index. The first match score is shown as match score 716 and the output dataset is shown at results 718 in FIG. 7.

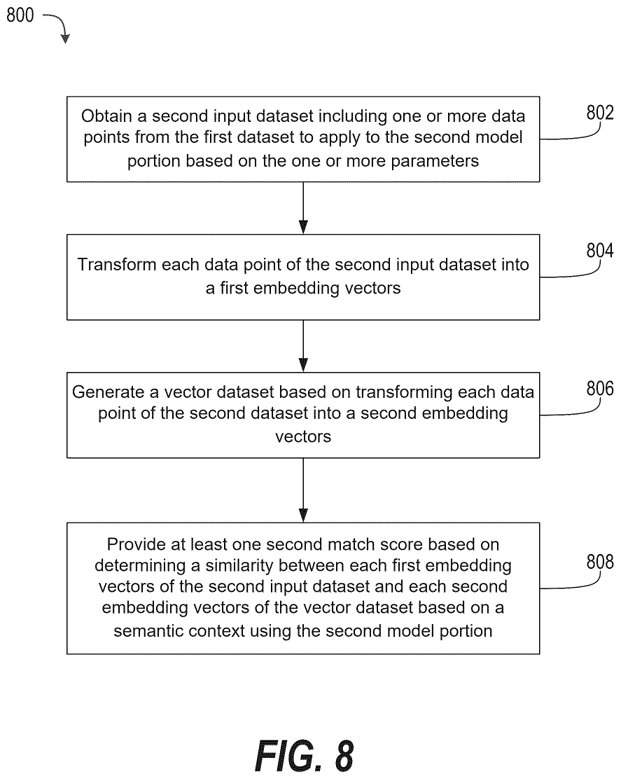

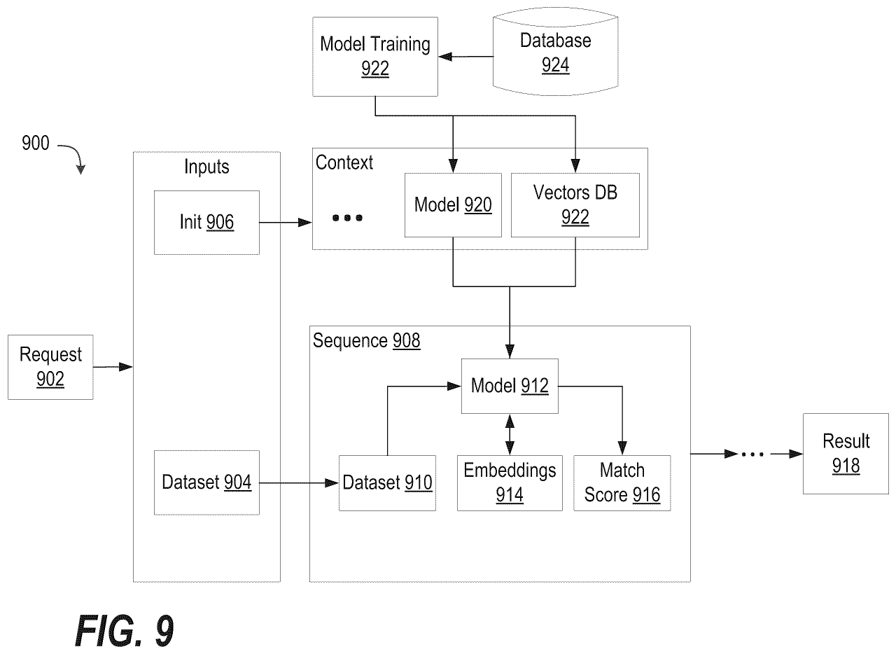

FIG. 8 is a flow diagram of an example method 800 for screening the user inputs, according to some embodiments. The method 800 can be an embodiment of operation 208 of method 200 of FIG. 2. The method 800 can be an embodiment of operations 602, 604, 606, and/or 608 of method 600 of FIG. 6. The method 800, or one or more portions of method 800, can be performed by screening system 102 in conjunction with transaction processing system 106, and thus can be computer-implemented. FIG. 9 is a block diagram of an example system 900 for screening the user inputs, according to some embodiments. The system 900 can be an embodiment of the screening system 102 of FIG. 1. The system 900 can be an embodiment of the system 300 of FIG. 3. The system 900 can be an embodiment of the system 500 of FIG. 5. The method 800 will be described in conjunction with the system 900.

According to some embodiments, the search model includes a second model portion, and providing the output dataset based on determining matches between the first dataset and the second dataset using the search model can include performing the operations of method 800. In some embodiments, the second model portion can be a semantic model configured to determine a semantic similarity between embedding vectors based on a respective location in a vector space utilizing an algorithm. In some embodiments, the second model portion can utilize a classifier algorithm to determine the semantic similarity between embeddings. In some embodiments, the second model portion can utilize a KNN classifier algorithm to determine the semantic similarity between embeddings.

At 802, the method 800 can include obtaining a second input dataset including one or more data points from the first dataset to apply to the second model portion based on the one or more parameters. The first dataset can include one or more user inputs of the user request. The one or more user inputs can define one or more user input fields from the second computing device initiating the electronic transaction. The obtained second input dataset can include one or more of the user input fields according to the user request. For example, the second input dataset can include a source entity name or a target entity name. In some embodiments, the second input dataset can include other data. The other data can include one or more results from the first model portion, in some embodiments. The other data can be associated with a user initiating the electronic transaction, in some embodiments. The other data can be associated with attributes of the other users associated with the transaction, in some embodiments.

For example, the other data can include account data, device data, location data, language data, user behavior data, historical data, other like data associated with users of the transaction processing system, or any combination thereof. The other data can include attributes of the one or more lists from the one or more data sources. For example, the other data of the second input dataset can include a default language of the user inputs from the second computing device according to the user account data and a translation language of the list that is obtained from the one or more data sources. The user request received from the first computing device is shown as 902, the first dataset defining the parameters of the search sequences is shown as dataset 904, the search sequence is shown as sequence 908, and the second input dataset is shown as dataset 910 in FIG. 9.

At 804, the method 800 can include transforming each data point of the second input dataset into a first embedding vectors. Each data point of the second input dataset can be transformed into embeddings vectors using an embedding model. In some embodiments, a dataset can include text strings representative of words, sentences, paragraphs, etc., and the embedding model can be applied to the data to transform the text strings into embeddings vectors representative of the meaning of the word, sentences, paragraphs, etc. For example, each character of a text string can be transformed into one or more embeddings vectors, and the character embeddings of the word can be concatenated into a word embeddings representative of the word's meaning based on a context of the other words in the phrase or sentence, the electronic transaction, etc. In some embodiments, the search model can include the embedding model. In some embodiments, the second model portion can include the embedding model. The first embedding vectors is shown as embeddings 914 and the embedding model is shown as model 920 in FIG. 9.

At 806, the method 800 can include generating a vector dataset based on transforming each data point of the second dataset into a second embedding vectors. The second dataset includes a dataset (i.e., list) from the one or more data sources such as, for example, data source 104 of FIG. 1. In some embodiments, the second dataset can include the index utilized by the first model portion, and the vector dataset can be based on transforming each text string of the index into the second embedding vectors. The second dataset can be applied to the embedding model to transform each data point of the second dataset into the second embedding vectors. In some embodiments, the second model portion can include the embedding model, and the second dataset can be applied to the second model portion to transform each data point into the second embedding vectors. The vector database including the second embeddings vectors is shown at vectors database (DB) 922 in FIG. 9.

In some embodiments, the embedding model can be trained using the second dataset, e.g., the list from the one or more data sources. In some embodiments, the list from the one or more data sources can be utilized to generate the index utilized by the first model portion from method 600 of FIG. 6 and can be utilized to train the embedding model and generate the vector dataset. For example, the index can include text strings of entities names of the sanctions list and the embedding model can be trained using the sanctions list. The embedding model training is shown as model training 922 and the one or more data sources is shown as database 924.

At 808, the method 800 can include providing at least one second match score based on determining a similarity between each first embedding vectors of the second input dataset and each second embedding vectors of the vector dataset based on a semantic context using the second model portion. That is, the second model portion can output a second match score having a value indicative of a similarity between the first embedding vectors representative of the user input field and the second embedding vectors representative of a data point in the vector DB. In some embodiments, the value of each second match score can be indicative of the predictive similarity between the first embedding vectors and the second embedding vectors. In some embodiments, the second model portion can compare the first embedding vectors to each of the second embedding vectors and the second model portion can generate a second model score that can be associated with each embedding pair.

In some embodiments, the second input dataset can include a plurality of user input fields that are transformed into first embedding vectors using the first model, and the second model portion can output a second match score for each of these first embedding vectors based on the comparison to each of the second embedding vectors of the vector DB. In some embodiments, the second model portion can compare the first embedding vectors to each of the second embedding vectors and the second model portion can output a second model score that has the highest score value of the embedding pairs. The second match scores determined by the second model portion are shown as match score 916 in FIG. 9.

In some embodiments, the output dataset provided by the search model can include the at least one second match score. In some embodiments, the output dataset provided by the search model can include a second match score for each of the user input fields that is a match to a data entry in the list based on a distance between the first embedding vectors and the second embedding vectors in the vector space. In some embodiments, the output dataset provided by the search model can include the second match score based on the second match score value exceeding a certain threshold limit.

In some embodiments, the second input dataset for the second model portion can further include at least one first match score output by the first model portion. In some embodiments, the at least one first match score can be associated with a user input field of the first input dataset. In some embodiments, the word from the user input field and the first match score can be obtained by the second model portion as input, the text string of the word can be transformed into a first embedding vectors, and the second model portion can utilize one or more algorithms to determine whether the user input field is a match with one of the data points of the vector DB. In FIG. 9, the dataset 910 can include the second input dataset, which can be obtained based on the user inputs of the user request, which is shown as request 902, according to some embodiments.

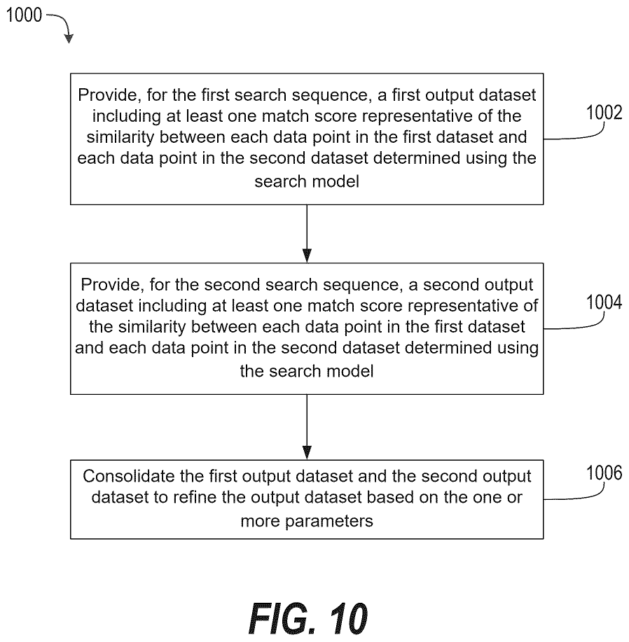

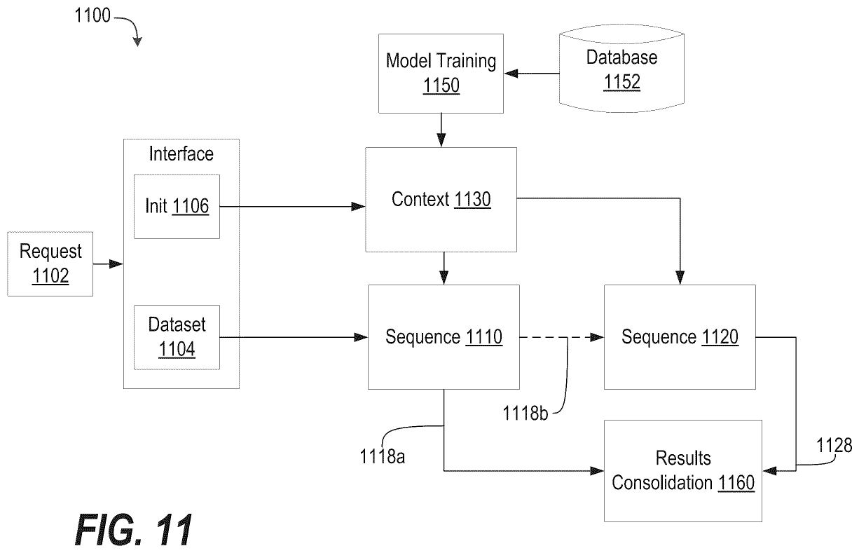

FIG. 10 is a flow diagram of an example method 1000 for screening the user inputs, according to some embodiments. The method 1000, or one or more portions thereof, can be an embodiment of operation 208 of method 200 of FIG. 2. The method 1000, or one or more portions thereof, can be an embodiment of operations 602, 604, 606, 608 of method 600 of FIG. 6. The method 1000, or one or more portions thereof, can be an embodiment of operations 802, 804, 806, 808 of method 800 of FIG. 8. The method 1000 can be performed using screening system 102 in conjunction with transaction processing system 106 of FIG. 1, and thus can be computer-implemented. FIG. 11 is a block diagram of an example system 1100 for screening the user inputs, according to some embodiments. The system 1100 can be an embodiment of screening system 102 of FIG. 1. The system 1100 can be an embodiment of the system 300 of FIG. 3. The system 1100 can be an embodiment of the system 500 of FIG. 5. The system 1100 can be an embodiment of the system 700 of FIG. 7. The system 1100 can be an embodiment of the system 900 of FIG. 9. The method 1000 will be described in conjunction with system 1100.

The user request can define one or more search sequences that are to be performed on data including the user input fields and the data from the one or more data sources using the search model. The user request can also configure the operations that are performed at each search sequence. In some embodiments, the at least one search sequence can include a first sequence. In some embodiments, the at least one search sequence can include a first search sequence and a second search sequence. In some embodiments, the at least one search sequence can include two or more search sequences.

According to some embodiments, the at least one search sequence can include a first search sequence and a second search sequence, and wherein providing the output dataset can include performing the method 1000, or one or more portions of the method 1000.

At 1002, the method 1000 can include providing, for the first search sequence, a first output dataset including at least one match score representative of the similarity between each data point in the first dataset and each data point in the second dataset determined using the search model. In some embodiments, each data point of the first output dataset can include at least one match score for each user input field of the first dataset received by the first search sequence. In some embodiments, the first search sequence can receive a subset of the user input fields of the first dataset according to the input conditions of the user request, and each data point of the first output dataset can include at least one match score for each of the subset of the user input fields of the first dataset. For example, the first search sequence can apply the search model to one or more inputs of the first dataset defined according to the input conditions of the user request. The first search sequence is shown as sequence 1110 in FIG. 11.

At 1004, the method 1000 can include providing, for the second search sequence, a second output dataset including at least one match score representative of the similarity between each data point in the first dataset and each data point in the second dataset determined using the search model. In some embodiments, each data point of the second output dataset can include at least one match score for each user input field of the first dataset received by the first search sequence. In some embodiments, the second search sequence can receive a subset of the user input fields of the first dataset according to the input conditions of the user request, and each data point of the second output dataset can include at least one match score for each of the subset of the user input fields of the first dataset. For example, the first search sequence can apply the search model to one or more inputs of the first dataset based on the input conditions received from the user request. The second search sequence is shown as sequence 1120 in FIG. 11.

At 1006, the method 1000 can include consolidating the first output dataset and the second output dataset to refine the output dataset based on the one or more parameters. In some embodiments, refining the output dataset can include filtering data points from the first output dataset and the second output dataset based on the corresponding match scores. For example, data points having match scores that are less than a certain defined threshold can be removed from the output dataset. In some embodiments, refining the output dataset can include removing duplicate data points. For example, for data points that are representative of the same user input field (e.g., same entity name), one of the data points can be removed from the output dataset. The consolidating of the first output dataset and the second output dataset is shown at block 1160.

According to some embodiments, the method 1000 can include consolidating the results of the output dataset. In some embodiments, the output dataset of each respective search sequence can be consolidated into the output dataset of method 200. The first output dataset is shown at reference number 1118a and the second output dataset is shown at reference number 1128 in FIG. 11. In some embodiments, the first output dataset from the first search sequence, or one or more data points of the first output dataset, can be received as one or more input fields by the second search sequence, and the output dataset from the second search sequence can be consolidated into the output dataset of method 200. The first output dataset received by the second search sequence is shown as reference number 1118b in FIG. 11. In some embodiments, the output dataset from the first search sequence can be received as one or more input fields by the second search sequence, and the output dataset from each of the first and second search sequences can be consolidated into the output dataset of method 200. For example, the output dataset from the first search sequence can include an entity that is determined to match a first list by the search model, and the second search sequence can receive the entity name to determine whether the input matches a second list by the search model, and the first and second output datasets can be consolidated so that the output dataset only includes one data entry of the entity name.

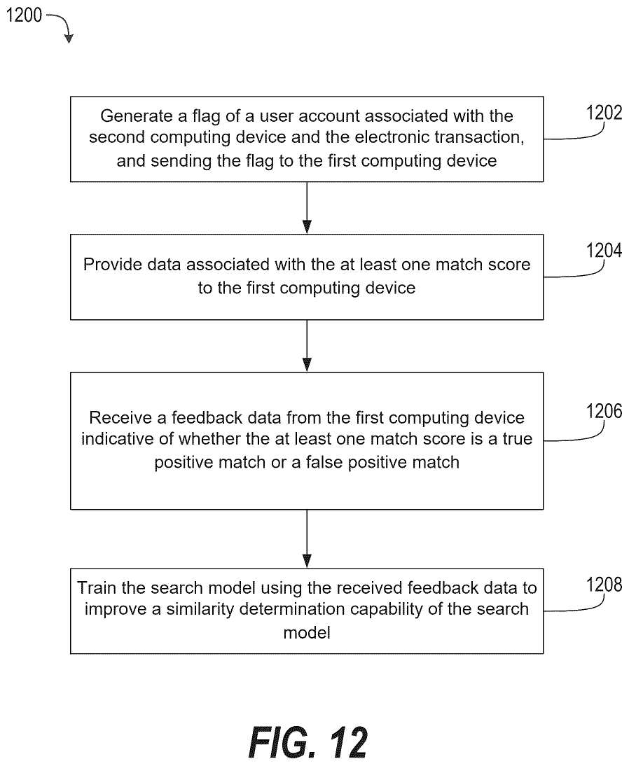

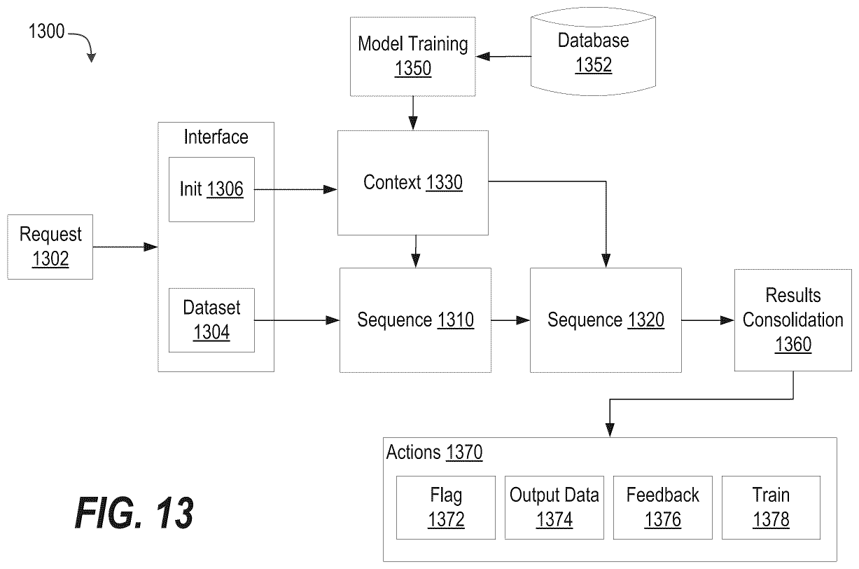

FIG. 12 is a flow diagram of an example method 1200 for screening the user inputs, according to some embodiments. The method 1200, or one or more portions thereof, can be an embodiment of operation 210 of method 200 of FIG. 2. The method 1200, or one or more portions thereof, can be an embodiment of operation 608 of method 600 of FIG. 6. The method 1200, or one or more portions thereof, can be an embodiment of operations 808 of method 800 of FIG. 8. The method 1200, or one or more portions thereof, can be an embodiment of operations 1002, 1004, 1006 of method 1000 of FIG. 10. The method 1200 can be performed using screening system 102 in conjunction with transaction processing system 106 of FIG. 1, and thus can be computer-implemented. FIG. 13 is a block diagram of an example system 1300 for screening the user inputs, according to some embodiments. The system 1300 can be an embodiment of the screening system 102 of FIG. 1. The system 1300 can be an embodiment of the system 300 of FIG. 3. The system 1300 can be an embodiment of the system 500 of FIG. 5. The system 1300 can be an embodiment of the system 700 of FIG. 7. The system 1300 can be an embodiment of the system 900 of FIG. 9. The system 1300 can be an embodiment of the system 1100 of FIG. 11. The method 1200 will be described in conjunction with system 1300.

According to some embodiments, in response to the at least one match score exceeding the certain threshold, the screening system can perform one or more pre-defined actions including the operations of method 1200, or one or more portions of method 1200.

At 1202, the method 1200 can include generating a flag of a user account associated with the second computing device and the electronic transaction, and sending the flag to the first computing device. The flag can be representative of the user input field associated with the electronic transaction matching one or more lists from the one or more data sources. For example, the screening system can flag an electronic transaction when an entity name from one of the user input fields for the electronic transaction matches one of the entities names in the sanctions list. In some embodiments, the flag can prevent the electronic transaction from being completed until an authorization is received from the first computing device or some other computing device of the entity. For example, the first computing device can be a sanctions adjudication agent of the entity. The flag is shown as flag 1372 in FIG. 13.

At 1204, the method 1200 can include providing data associated with the at least one match score to the first computing device. The output dataset including the at least one match score can be provided to the first computing device, or some other computing device associated with the entity. The output dataset is shown as output data 1374 in FIG. 13.

At 1206, the method 1200 can include receiving a feedback data from the first computing device indicative of whether the at least one match score is a true positive match or a false positive match. The feedback data can be provided as inputs by a user of the first computing device. The feedback data can be indicative of, for example, a false positive decision or a true positive decision by the search model and the screening system. The feedback data is shown as feedback data 1376 in FIG. 13.

At 1208, the method 1200 can include training the search model using the received feedback data to improve a similarity determination capability of the search model. The search model can be trained using a training dataset including the feedback data to reduce the false positive decisions by the search model when determining whether the user input fields matches the one or more datasets from the one or more data sources. In this regard, the model training can also improve the true positive decisions by the search model when determining whether the user input fields matches the one or more datasets from the one or more data sources. The model training is shown as train 1378 in FIG. 13.

According to some embodiments, a match score exceeding the certain threshold limit can be indicative of a positive match determination by the search model. In some embodiments, in response to the match score exceeding the certain threshold limit, the screening system can generate a flag of a user account associated with the second computing device and the electronic transaction, and send the flag to the first computing device. In some embodiments, in response to the match score exceeding the certain threshold limit, the screening system can provide data associated with the at least one match score to the first computing device, and in response to the data provided to the first computing device, the screening system can receive feedback data from the first computing device indicative of whether the at least one match score is a true positive match or a false positive match. In some embodiments, in response to receiving the feedback data from the first computing device, the screening system can train the search model using the received feedback data to improve the similarity determination capability of the search model.

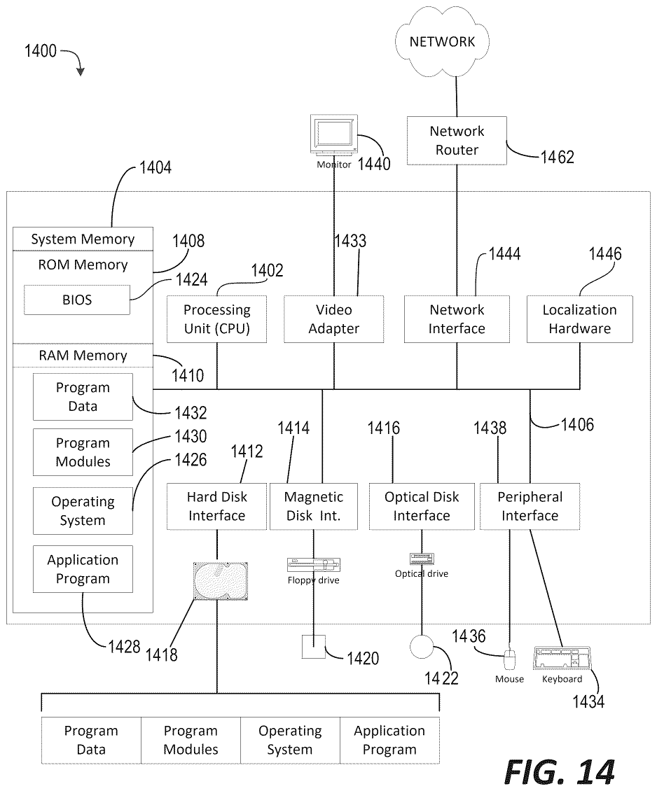

FIG. 14 is a block diagram of an example computing system 1400, according to some embodiments.

The computing system 1400 can be, for example, a desktop computer, laptop, smartphone, tablet, or any other such device having the ability to execute instructions, such as those stored within a non-transient, computer-readable medium. Furthermore, while described and illustrated in the context of a single computing system 1400, those skilled in the art will also appreciate that the various tasks described hereinafter can be practiced in a distributed environment having multiple computing systems 1400 linked via a local or wide-area network in which the executable instructions can be associated with and/or executed by one or more of multiple computing systems 1400.

In its most basic configuration, computing system environment 1400 typically includes at least one processing unit 1402 and at least one memory 1404, which can be linked via a bus 1406. Depending on the exact configuration and type of computing system environment, memory 1404 can be volatile (such as RAM 1410), non-volatile (such as ROM 1408, flash memory, etc.) or some combination of the two. Computing system environment 1400 can have additional features and/or functionality. For example, computing system environment 1400 can also include additional storage (removable and/or non-removable) including, but not limited to, magnetic or optical disks, tape drives and/or flash drives. Such additional memory devices can be made accessible to the computing system environment 1400 by means of, for example, a hard disk drive interface 1412, a magnetic disk drive interface 1414, and/or an optical disk drive interface 1416. As will be understood, these devices, which would be linked to the system bus 1406, respectively, allow for reading from and writing to a hard disk 1418, reading from or writing to a removable magnetic disk 1420, and/or for reading from or writing to a removable optical disk 1422, such as a CD/DVD ROM or other optical media. The drive interfaces and their associated computer-readable media allow for the nonvolatile storage of computer readable instructions, data structures, program modules and other data for the computing system environment 1400. Those skilled in the art will further appreciate that other types of computer readable media that can store data can be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media can be part of computing system environment 1400.

A number of program modules can be stored in one or more of the memory/media devices. For example, a basic input/output system (BIOS) 1424, containing the basic routines that help to transfer information between elements within the computing system environment 1400, such as during start-up, can be stored in ROM 1408. Similarly, RAM 1410, hard drive 1418, and/or peripheral memory devices can be used to store computer executable instructions comprising an operating system 1426, one or more applications programs 1428, other program modules 1430, and/or program data 1432. Still further, computer-executable instructions can be downloaded to the computing environment 1400 as needed, for example, via a network connection. The applications programs 1428 can include, for example, a browser, including a particular browser application and version, which browser application and version can be relevant to determinations of correspondence between communications and user URL requests, as described herein. Similarly, the operating system 1426 and its version can be relevant to determinations of correspondence between communications and user URL requests, as described herein.

An end-user can enter commands and information into the computing system environment 1400 through input devices such as a keyboard 1434 and/or a pointing device 1436. While not illustrated, other input devices can include a microphone, a joystick, a game pad, a scanner, etc. These and other input devices would typically be connected to the processing unit 1402 by means of a peripheral interface 1438 which, in turn, would be coupled to bus 1406. Input devices can be directly or indirectly connected to processor 1402 via interfaces such as, for example, a parallel port, game port, firewire, or a universal serial bus (USB). To view information from the computing system environment 1400, a monitor 1440 or other type of display device can also be connected to bus 1406 via an interface, such as via video adapter 1433. In addition to the monitor 1440, the computing system environment 1400 can also include other peripheral output devices, not shown, such as speakers and printers.

The computing system environment 1400 can also utilize logical connections to one or more computing system environments. Communications between the computing system environment 1400 and the remote computing system environment can be exchanged via a further processing device, such a network router 1448, that is responsible for network routing. Communications with the network router 1448 can be performed via a network interface component 1444. Thus, within such a networked environment, e.g., the Internet, World Wide Web, LAN, or other like type of wired or wireless network, it will be appreciated that program modules depicted relative to the computing system environment 1400, or portions thereof, can be stored in the memory storage device(s) of the computing system environment 1400.

The computing system environment 1400 can also include localization hardware 1446 for determining a location of the computing system environment 1400. In embodiments, the localization hardware 1446 can include, for example only, a GPS antenna, an RFID chip or reader, a WiFi antenna, or other computing hardware that can be used to capture or transmit signals that can be used to determine the location of the computing system environment 1400. Data from the localization hardware 1446 can be included in a callback request or other user computing device metadata in the methods of this disclosure.

The computing system, or one or more portions thereof, can embody a user computing device 148, in some embodiments. Additionally, or alternatively, some components of the computing system 1400 can embody the screening system 102 and/or transaction processing system 106. For example, one or more of the functional modules 120, 122, 124, 126, 128 can be embodied as program modules 1430. For example, the search module 126 can be embodied as program modules 1430. In another example, the context module 124 can be embodied as program modules 1430. Some components of the computing system 1400 can embody system 300, 400, 500, 700, 900, 1100, 1300. For example, the context module 124 can be embodied as program modules 1430.

In some embodiments, a computer-implemented method for screening user accounts includes receiving a user request including one or more inputs for generating at least one search sequence from a first computing device. In some embodiments, the one or more inputs defines one or more parameters for the at least one search sequence. In some embodiments, the at least one search sequence is associated with an electronic transaction. In some embodiments, the computer-implemented method for screening user accounts includes obtaining, for the at least one search sequence, a first dataset associated with the electronic transaction based on the one or more parameters. In some embodiments, each data point of the first dataset includes a user input obtained from a second computing device. In some embodiments, the computer-implemented method for screening user accounts includes obtaining, for the at least one search sequence, a second dataset for matching with the first dataset based on the one or more parameters. In some embodiments, the computer-implemented method for screening user accounts includes providing, for the at least one search sequence, an output dataset including at least one match score based on determining a similarity between at least one data point of the first dataset and at least one data point of the second dataset using a search model. In some embodiments, the computer-implemented method for screening user accounts includes performing one or more pre-defined actions in response to the at least one match score exceeding a certain threshold. In some embodiments, the at least one match score exceeding the certain threshold is indicative of a positive match between the first dataset and the second dataset.

In some embodiments, the search model includes a first model portion. In some embodiments, the computer-implemented method for screening user accounts includes further includes obtaining a first input dataset including one or more data points from the first dataset to apply to the first model portion based on the one or more parameters; partitioning each data point of the first input dataset into a first text string; generating an index based on partitioning each data point of the second dataset into a second text string; and providing at least one first match score based on determining a similarity between each first text string of the first input dataset and each second text string of the index using the first model portion. In some embodiments, the output dataset includes the at least one first match score.

In some embodiments, the search model includes a second model portion. In some embodiments, providing the output dataset based on determining matches between the first dataset and the second dataset using the search model includes obtaining a second input dataset including one or more data points from the first dataset to apply to the second model portion based on the one or more parameters; transforming each data point of the second input dataset into a first embedding vectors; generating a vector dataset based on transforming each data point of the second dataset into a second embedding vectors; and providing at least one second match score based on determining a similarity between each first embedding vectors of the second input dataset and each second embedding vectors of the vector dataset based on a semantic context using the second model portion. In some embodiments, the output dataset includes the at least one second match score.

In some embodiments, the first model portion is a keyword model, and the first model portion utilizes at least one of an exact search algorithm or a fuzzy search algorithm to determine the similarity between the first input dataset and the index. In some embodiments, the second model portion is a semantic model, and the second model portion determines a semantic similarity between embedding vectors based on a respective location in a vector space utilizing a classifier algorithm.

In some embodiments, the second input dataset for the second model portion further includes the at least one first match score output by the first model portion.

In some embodiments, the at least one search sequence includes a first search sequence and a second search sequence. In some embodiments, providing the output dataset further includes providing, for the first search sequence, a first output dataset including at least one match score representative of the similarity between each data point in the first dataset and each data point in the second dataset determined using the search model; providing, for the second search sequence, a second output dataset including at least one match score representative of the similarity between each data point in the first dataset and each data point in the second dataset determined using the search model; and consolidating, for a third search sequence, the first output dataset and the second output dataset to refine the output dataset based on the one or more parameters. In some embodiments, the refined output dataset includes at least one match score from the first output dataset and the second output dataset.

In some embodiments, the first dataset includes one or more entities names associated with the electronic transaction. In some embodiments, the one or more entities names are determined from one or more user inputs obtained from the second computing device, and the second dataset includes a plurality of entities names obtained from one or more data sources including at least one of: a sanctions list, wherein the sanctions list correspond to entities sanctioned by a regulatory authority; a sanctions adjudication list, wherein the sanctions adjudication list corresponds to entities names having been reviewed according to a sanctions adjudications process; or a watchlist, wherein the watchlist corresponds to entities names suspected of malicious electronic activity in a system associated with the search model.

In some embodiments, the first dataset further includes data associated with a user of the second computing device including at least one of: account data, personal data, device data, location data, language data, or user behavior data.

In some embodiments, performing the one or more pre-defined actions in response to the at least one match score exceeding the certain threshold includes generating a flag of a user account associated with the second computing device and the electronic transaction, and sending the flag to the first computing device; providing data associated with the at least one match score to the first computing device; receiving a feedback data from the first computing device indicative of whether the at least one match score is a true positive match or a false positive match; and training the search model using the received feedback data to improve a similarity determination capability of the search model. In some embodiments, the flag prevents the electronic transaction from completing until an authorization is received from the first computing device.

In some embodiments, a system includes a processor; and a non-transitory computer readable medium having stored thereon instructions that are executable by the processor to enable the system to perform operations. In some embodiments, the operations performed by the system include receive a user request including one or more inputs for generating at least one search sequence from a first computing device. In some embodiments, the one or more inputs defines one or more parameters for the at least one search sequence. In some embodiments, the at least one search sequence is associated with an electronic transaction. In some embodiments, the operations performed by the system include obtain, for the at least one search sequence, a first dataset including one or more entities names associated with the electronic transaction based on the one or more parameters. In some embodiments, each data point of the first dataset includes a user input obtained from a second computing device. In some embodiments, the operations performed by the system include obtain, for the at least one search sequence, a second dataset including a plurality of entities names for matching with the first dataset based on the one or more parameters. In some embodiments, the operations performed by the system include provide, for the at least one search sequence, at least one first match score based on determining a text-based similarity between each data point of the first dataset and each data point of the second dataset using a first model portion. In some embodiments, the operations performed by the system include provide, for the at least one search sequence, at least one second match score based on determining a semantic similarity between each data point of the first dataset and each data point of the second dataset using a second model portion. In some embodiments, the operations performed by the system include perform one or more pre-defined actions in response to at least one match score in an output dataset exceeding a certain threshold. In some embodiments, the one or more pre-defined actions includes generating a flag of a user account associated with the second computing device and the electronic transaction, and sending the flag to the first computing device. In some embodiments, the flag prevents the electronic transaction from completing until an authorization is received from the first computing device. In some embodiments, the output dataset is generated based on the at least one first match score and the at least one second match score. In some embodiments, at least one match score of the output dataset exceeding the certain threshold is indicative of a positive match between the first dataset and the second dataset.

In some embodiments, providing the at least one first match score using the first model portion includes obtain a first input dataset including one or more data points from the first dataset to apply to the first model portion based on the one or more parameters. In some embodiments, providing the at least one first match score using the first model portion includes partition each data point of the first input dataset into a first text string. In some embodiments, providing the at least one first match score using the first model portion includes generate an index based on partitioning each data point of the second dataset into a second text string. In some embodiments, providing the at least one first match score using the first model portion includes determine the text-based similarity between each first text string of the first input dataset and each second text string of the index using the first model portion. In some embodiments, the at least one first match score is representative of the text-based similarity determined using the first model portion, wherein the first model portion is a keyword model. In some embodiments, the first model portion utilizes at least one of an exact search algorithm or a fuzzy search algorithm to determine the text-based similarity between the first input dataset and the index.

In some embodiments, providing the at least one second match score using the second model portion includes obtain a second input dataset including one or more data points from the first dataset to apply to the second model portion based on the one or more parameters. In some embodiments, providing the at least one second match score using the second model portion includes transform each data point of the second input dataset into a first embedding vectors. In some embodiments, providing the at least one second match score using the second model portion includes generate a vector dataset based on transforming each data point of the second dataset into a second embedding vectors. In some embodiments, providing the at least one second match score using the second model portion includes determine the semantic similarity between each first embedding vectors representative of the second input dataset and each second embedding vectors representative of the vector dataset using the second model portion. In some embodiments, the at least one second match score is representative of the semantic similarity determined using the second model portion. In some embodiments, the second model portion is a semantic model. In some embodiments, the second model portion utilizes a classifier algorithm to determine the semantic similarity between the second input dataset and the vector dataset.

In some embodiments, the second input dataset for the second model portion further includes the at least one first match score output by the first model portion.

In some embodiments, the at least one search sequence includes a first search sequence and a second search sequence. In some embodiments, providing the output dataset includes provide, for the first search sequence, a first output dataset including at least one match score representative of a similarity between each data point in the first dataset and each data point in the second dataset determined using a search model. In some embodiments, providing the output dataset includes provide, for the second search sequence, a second output dataset including at least one match score representative of the similarity between each data point in the first dataset and each data point in the second dataset determined using the search model. In some embodiments, providing the output dataset includes consolidate, for a third search sequence, the first output dataset and the second output dataset to refine the output dataset based on the one or more parameters. In some embodiments, the refined output dataset includes at least one match score from the first output dataset and the second output dataset.

In some embodiments, the one or more entities names are determined from one or more user inputs obtained from the second computing device, and the plurality of entities names are obtained from one or more data sources including at least one of: a sanctions list, wherein the sanctions list corresponds to entities names sanctioned by a regulatory authority; a sanctions adjudication list, wherein the sanctions adjudication list corresponds to entities names having been reviewed according to a sanctions adjudications process; or a watchlist, wherein the watchlist corresponds to entities names suspected of malicious electronic activity in the system.

In some embodiments, the first dataset further includes data associated with a user of the second computing device including at least one of: account data, personal data, device data, location data, language data, or user behavior data.

In some embodiments, a non-transitory computer readable medium having stored thereon instructions that are executable by a processor of a computing system to enable the computing system to perform operations including receive a user request including one or more inputs for generating a plurality of search sequences from a first computing device. In some embodiments, the one or more inputs defines one or more parameters for the plurality of search sequences. In some embodiments, the plurality of search sequences includes a first search sequence and a second search sequence associated with an electronic transaction. In some embodiments, the operations performed by the computing include obtain, for each of the first and second search sequences, a first dataset including one or more entities names associated with the electronic transaction based on the one or more parameters. In some embodiments, each data point of the first dataset includes a user input obtained from a second computing device. In some embodiments, the operations performed by the computing include obtain, for each of the first and second search sequences, a second dataset including a plurality of external entities names for matching with the first dataset based on the one or more parameters. In some embodiments, the operations performed by the computing include provide, for the first search sequence, a first output dataset including at least one match score representative of a similarity between each data point in the first dataset and each data point in the second dataset determined using a search model. In some embodiments, the operations performed by the computing include provide, for the second search sequence, a second output dataset including at least one match score representative of a similarity between each data point in the first dataset and each data point in the second dataset determined using the search model. In some embodiments, the operations performed by the computing include consolidate, for a third search sequence, the first output dataset and the second output dataset to refine an output dataset based on the one or more parameters. In some embodiments, the operations performed by the computing include provide the refined output dataset to the first computing device. In some embodiments, the operations performed by the computing include receive a feedback data from the first computing device indicative of whether each match score is a true positive match or a false positive match for the refined output dataset. In some embodiments, the operations performed by the computing include train the search model using the received feedback data to improve a similarity determination capability of the search model; and perform one or more pre-defined actions in response to a match score in the refined output dataset exceeding a certain threshold. In some embodiments, the match score in the refined output dataset exceeding the certain threshold is indicative of a positive match between the first dataset and the second dataset.

In some embodiments, for each of the first and second search sequences, providing the first output dataset or the second output dataset includes obtain a first input dataset including one or more data points from the first dataset to apply to a first model portion based on the one or more parameters; partition each data point of the first input dataset into a first text string; generate an index based on partitioning each data point of the second dataset into a second text string; and providing a set of first match scores based on determining a similarity between each first text string of the first input dataset and each second text string of the index using a first model portion. In some embodiments, the output dataset includes at least one of the set of first match scores. In some embodiments, the first model portion is a keyword model. In some embodiments, the first model portion utilizes at least one of an exact search algorithm or a fuzzy search algorithm to determine the similarity between the first input dataset and the index.

In some embodiments, for each of the first and second search sequences, providing the first output dataset or the second output dataset includes: obtain a second input dataset including one or more data points from the first dataset to apply to a second model portion based on the one or more parameters; transform the one or more data points of the second input dataset into a first embedding vectors; generate a vector dataset including a second embedding vectors transformed from each data point in the second dataset; and provide a set of second match scores representative of the determined similarity between each first embedding vector of the second input dataset and each second embedding vector of the vector dataset based on a semantic context using the second model portion. In some embodiments, the output dataset includes at least one of the set of second match scores. In some embodiments, the second model portion is a semantic model. In some embodiments, the second model portion determines a semantic similarity between embedding vectors based on respective locations in a vector space utilizing a classifier algorithm.

In some embodiments, the one or more entities names of the first dataset are determined from one or more user inputs obtained from the second computing device, and the plurality of external entities names of the second dataset are obtained from one or more data sources including at least one of: a sanctions list, wherein the sanctions list corresponds to entities names sanctioned by a regulatory authority; a sanctions adjudication list, wherein the sanctions adjudication list corresponds to entities names having been reviewed according to a sanctions adjudications process; or a watchlist, wherein the watchlist corresponds to entities names suspected of malicious electronic activity in the computing system.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

1. A computer-implemented method for screening user accounts comprising:
receiving a user request comprising one or more inputs for generating at least one search sequence from a first computing device, wherein the one or more inputs defines one or more parameters for the at least one search sequence, wherein the at least one search sequence is to screen one or more users associated with an electronic transaction;
obtaining, for the at least one search sequence, a first dataset including user data associated with the electronic transaction, wherein the first dataset is obtained based on a user input from a second computing device;
obtaining, for the at least one search sequence, a second dataset comprising one or more indexes for matching with the first dataset based on the one or more parameters;
providing, by a hybrid search model for the at least one search sequence, a positive match identification comprising at least one match result based on the first dataset and the second dataset, wherein providing the positive match identification comprises:
performing, by a first model portion, a first search sequence to output a first set of matches identified based on a lexical similarity between a first set of text strings representative of the first dataset and a second set of text strings representative of the second dataset, the first model portion generating, for each match, a first match score,
performing, by a second model portion, a second search sequence to output a second set of matches identified based on a semantic similarity based on a proximity between a first set of embedding vectors representative of the first dataset and a second set of embedding vectors representative of the second dataset in a vector space, the second model portion generating, for each match, a second match score, and
consolidating the first set of matches and the second set of matches to output at least one match result based on the positive match identification according to the respective first and second match scores,
wherein, in response to the first set of matches including a partial match, the second model portion is configured to identify the semantic similarity between an embedding vector representative of the partial match and the second set of embedding vectors representative of the second dataset; and
performing one or more pre-defined actions in response to the positive match identification of the at least one match result,
wherein the positive match identification is based on a consolidated match score of the respective first and second match scores output by the respective first and second model portions exceeding a certain threshold.

2. The computer-implemented method of claim 1, wherein the method further comprises:
obtaining a first input dataset comprising one or more data points from the first dataset to apply to the first model portion based on the one or more parameters;
partitioning each data point of the first input dataset into a first text string;
partitioning each data point of the second dataset into a second text string; and
providing the first set of matches as output based on determining the lexical similarity between each first text string of the first input dataset and each second text string of a respective index of the second dataset using the first model portion,
wherein the respective first match score of the first set of matches is indicative of the first text string being a full or partial match to the second dataset.

3. The computer-implemented method of claim 2, wherein the method further comprises:
obtaining a second input dataset comprising one or more data points from the first dataset to apply to the second model portion based on the one or more parameters;
transforming each data point of the second input dataset into a first embedding vectors;
generating a vector dataset based on transforming each data point of the second dataset into a second embedding vectors; and
providing the second set of matches as output based on determining the semantic similarity between each first embedding vectors of the second input dataset and each second embedding vectors of the vector dataset based on a semantic context using the second model portion.

4. The computer-implemented method of claim 3, wherein:
the first model portion is a keyword model, and the first model portion utilizes at least one of an exact search algorithm or a fuzzy search algorithm to determine the similarity between the first input dataset and the index, and
the second model portion is a semantic model, and the second model portion determines the semantic similarity between embedding vectors based on a respective location in a vector space utilizing a classifier algorithm.

5. The computer-implemented method of claim 3, wherein the second input dataset for the second model portion further comprises at least one of the first set of matches based on the respective first match score exceeding a first threshold, the first match score exceeding the first threshold indicative of the partial match.

6. (canceled)

7. The computer-implemented method of claim 1, wherein:
the first dataset comprises one or more entities names associated with the electronic transaction, and wherein the one or more entities names are determined from one or more user inputs obtained from the second computing device, and
the second dataset comprises a plurality of entities names obtained from one or more data sources comprising at least one of:
a sanctions list,
wherein the sanctions list correspond to entities sanctioned by a regulatory authority;
a sanctions adjudication list,
wherein the sanctions adjudication list corresponds to entities names having been reviewed according to a sanctions adjudications process; or
a watchlist,
wherein the watchlist corresponds to entities names suspected of malicious electronic activity in a system associated with the search model.

8. The computer-implemented method of claim 7, wherein the first dataset further comprises data associated with a user of the second computing device including at least one of:
account data, personal data, device data, location data, language data, or user behavior data.

9. The computer-implemented method of claim 1, wherein performing the one or more pre-defined actions in response to the at least one match score exceeding the certain threshold comprises:
generating a flag of a user account associated with the second computing device and the electronic transaction, and sending the flag to the first computing device;
providing data associated with the at least one match score to the first computing device;
receiving a feedback data from the first computing device indicative of whether the at least one match score is a true positive match or a false positive match; and
training the search model using the received feedback data to improve a similarity determination capability of the search model,
wherein the flag prevents the electronic transaction from completing until an authorization is received from the first computing device.

10. A system comprising:
a processor; and
a non-transitory computer readable medium having stored thereon instructions that are executable by the processor to enable the system to perform operations comprising:
receive a user request comprising one or more inputs for generating at least one search sequence from a first computing device, wherein the one or more inputs defines one or more parameters for the at least one search sequence, and wherein the at least one search sequence is to screen entities associated with an electronic transaction;
obtain, for the at least one search sequence, a first dataset comprising one or more entities names associated with the electronic transaction based on the one or more parameters, wherein each data point of the first dataset is obtained based on a user input from a second computing device;
obtain, for the at least one search sequence, a second dataset comprising a plurality of entities names for matching with the first dataset based on the one or more parameters;
provide, by at least one search model for the at least one search sequence, a positive match identification comprising at least one match result and a corresponding at least one first match score based on the first dataset and the second dataset, wherein providing the positive match identification comprises:
provide, by a first model portion, at least one first match based on a text-based similarity between text strings of the first dataset and text strings of the second dataset, the at least one first match each comprising a first match score indicative of a full or partial match;
provide, by a second model portion, at least one second match based on a semantic similarity between first embedding vectors of the first dataset and second embedding vectors of the second dataset; and
consolidate the at least one first match and the at least one second match to output at least one match result based on the positive match identification according to the respective first and second match scores; and
perform one or more pre-defined actions in response to a respective match score of the at least one match result exceeding a certain threshold,
wherein the one or more pre-defined actions comprises generating a flag of a user account associated with the second computing device and the electronic transaction, and sending the flag to the first computing device, wherein the flag prevents the electronic transaction from completing until an authorization is received from the first computing device,
wherein the output dataset is generated based on consolidating the at least one first match and the at least one second match, and wherein a respective match score of the at least one match result exceeding the certain threshold is indicative of a positive match between the first dataset and the second dataset.

11. The system of claim 10, wherein providing the at least one first match score using the first model portion comprises:
obtain a first input dataset comprising one or more data points from the first dataset to apply to the first model portion based on the one or more parameters;
partition each data point of the first input dataset into a first text string;
generate an index based on partitioning each data point of the second dataset into a second text string; and
provide the at least one first match based on determining a lexical similarity between each first text string of the first input dataset and each second text string of the index using the first model portion,
wherein the at least one first match score associated with the at least one first match is representative of the text-based similarity determined using the first model portion,
wherein the first model portion is a keyword model, and wherein the first model portion utilizes at least one of an exact search algorithm or a fuzzy search algorithm to determine the text-based similarity between the first input dataset and the index.

12. The system of claim 10, wherein providing the at least one second match score using the second model portion comprises:
obtain a second input dataset comprising one or more data points from the first dataset to apply to the second model portion based on the one or more parameters;
transform each data point of the second input dataset into a first embedding vectors;
generate a vector dataset based on transforming each data point of the second dataset into a second embedding vectors;
provide the at least one second match based on determining the semantic similarity between each first embedding vectors representative of the second input dataset and each second embedding vectors representative of the vector dataset using the second model portion; and
wherein the at least one second match score associated with the at least one second match is representative of the semantic similarity determined using the second model portion,
wherein the second model portion is a semantic model, and wherein the second model portion utilizes a classifier algorithm to determine the semantic similarity between the second input dataset and the vector dataset.

13. The system of claim 12, wherein the second input dataset for the second model portion further comprises the at least one first match score output by the first model portion.

14. (canceled)

15. The system of claim 10, wherein:
the one or more entities names are determined from one or more user inputs obtained from the second computing device, and
the plurality of entities names are obtained from one or more data sources comprising at least one of:
a sanctions list,
wherein the sanctions list corresponds to entities names sanctioned by a regulatory authority;
a sanctions adjudication list,
wherein the sanctions adjudication list corresponds to entities names having been reviewed according to a sanctions adjudications process; or
a watchlist,
wherein the watchlist corresponds to entities names suspected of malicious electronic activity in the system.

16. The system of claim 15, wherein the first dataset further comprises data associated with a user of the second computing device including at least one of: account data, personal data, device data, location data, language data, or user behavior data.

17. A non-transitory computer readable medium having stored thereon instructions that are executable by a processor of a computing system to enable the computing system to perform operations comprising:
receive a user request comprising one or more inputs for generating a plurality of search sequences from a first computing device, wherein the one or more inputs defines one or more parameters for the plurality of search sequences, wherein the plurality of search sequences comprises a first search sequence and a second search sequence associated with an electronic transaction;
obtain, for each of the first and second search sequences, a first dataset comprising one or more entities names associated with the electronic transaction based on the one or more parameters, wherein each data point of the first dataset comprises a user input obtained from a second computing device;
obtain, for each of the first and second search sequences, a second dataset comprising a plurality of external entities names for matching with the first dataset based on the one or more parameters;
provide, for the first search sequence, a first output dataset comprising at least one first match and at least one match score representative of a lexical similarity between each data point in the first dataset and each data point in the second dataset determined using a first model portion of the search model;
provide, for the second search sequence, a second output dataset comprising at least one second match and at least one match score representative of a semantic similarity between each data point in the first dataset and each data point in the second dataset determined using a second model portion of the search model, the first dataset further comprising a first match of the first output dataset in response to being a partial match;
consolidate, for a third search sequence, the first output dataset and the second output dataset to refine an output dataset comprising at least one match result corresponding to a positive match identification based on the respective first and second match scores;
provide the refined output dataset to the first computing device;
receive a feedback data from the first computing device indicative of whether each of the at least one match result is a true positive match or a false positive match for the refined output dataset;
train the search model using the received feedback data to improve a similarity determination capability of the search model; and
perform one or more pre-defined actions in response to a match score in the refined output dataset exceeding a certain threshold,
wherein the match score in the refined output dataset exceeding the certain threshold is indicative of a positive match between the first dataset and the second dataset.

18. The non-transitory computer readable medium of claim 17, wherein, for each of the first and second search sequences, providing the first output dataset or the second output dataset comprises:
obtain a first input dataset comprising one or more data points from the first dataset to apply to the first model portion based on the one or more parameters;
partition each data point of the first input dataset into a first text string;
generate an index based on partitioning each data point of the second dataset into a second text string; and
providing a set of first match scores associated with a set of first match results based on determining a similarity between each first text string of the first input dataset and each second text string of the index using a first model portion,
wherein the output dataset comprises the at least one first match result based on the set of first match scores,
wherein the first model portion is a keyword model, and wherein the first model portion utilizes at least one of an exact search algorithm or a fuzzy search algorithm to determine the similarity between the first input dataset and the index.

19. The non-transitory computer readable medium of claim 17, wherein, for each of the first and second search sequences, providing the first output dataset or the second output dataset comprises:
obtain a second input dataset comprising one or more data points from the first dataset to apply to a second model portion based on the one or more parameters;
transform the one or more data points of the second input dataset into a first embedding vectors;
generate a vector dataset comprising a second embedding vectors transformed from each data point in the second dataset; and
provide a set of second match scores associated with a set of second match results representative of the determined semantic similarity between each first embedding vector of the second input dataset and each second embedding vector of the vector dataset based on a semantic context using the second model portion,
wherein the output dataset comprises the at least one second match and a corresponding at least one second match score of the set of second match scores,
wherein the second model portion is a semantic model, and wherein the second model portion determines a semantic similarity between embedding vectors based on respective locations in a vector space utilizing a classifier algorithm.

20. The non-transitory computer readable medium of claim 17, wherein:
the one or more entities names of the first dataset are determined from one or more user inputs obtained from the second computing device, and
the plurality of external entities names of the second dataset are obtained from one or more data sources comprising at least one of:
a sanctions list,
wherein the sanctions list corresponds to entities names sanctioned by a regulatory authority;
a sanctions adjudication list,
wherein the sanctions adjudication list corresponds to entities names having been reviewed according to a sanctions adjudications process; or
a watchlist,
wherein the watchlist corresponds to entities names suspected of malicious electronic activity in the computing system.
